(19) United States
(12) Patent Application Publication
(10) Pub. No.: US 2026/0203447 A1
(43) Pub. Date: Jul. 16, 2026

(54) REDUCING PARTICIPANTS IN DATA PRIVACY INTEGRATION PROTOCOLS

(71) Applicant: SAP SE, Walldorf (DE)

(72) Inventors: Benny Rolle, Reinhardshagen (DE); Matthias Vogel, Saarbrücken (DE)

(21) Appl. No.: 19/018,790

(22) Filed: Jan. 13, 2025

(51) Int. Cl. G06F 21/62; G06F 21/60

(52) U.S. Cl. CPC G06F 21/6281; G06F 21/604

(57) ABSTRACT

The present disclosure involves systems, software, and computer implemented methods for data privacy. One example method includes receiving a first request to start a data privacy integration protocol for a first object instance. At least one second request is sent to at least one other service for information regarding which subset of applications of a multiple-application landscape have received a copy of the first object instance. A work package is created for the first object instance and the data privacy integration protocol and is sent to applications in the subset and not sent to landscape applications not in the subset. Work package responses are received from applications in the subset of applications. A data privacy integration protocol result is determined based on the work package responses and is sent in response to the first request to start the data privacy integration protocol.

### TECHNICAL FIELD

The present disclosure relates to computer-implemented methods, software, and systems for data privacy protocols.

### BACKGROUND

Applications used for organizations can use master data (such as name and address) and transactional data (such as orders and bills). Transactional data typically references corresponding master data. For instance, a transactional object of type Order can refer to a master data object of type Customer. A given master data object can be referenced by one or more (or perhaps no) transactional objects. In some cases, data may be considered master data in one context and transactional data in another context. For example, insurance contract data may be considered transactional data with respect to a customer object but considered master data with respect to transactional insurance claim data. When an organizational landscape includes multiple systems, a master data replication process can be performed so that master data objects are consistent across systems.

### SUMMARY

The present disclosure involves systems, software, and computer implemented methods for data privacy protocols. An example method includes: receiving, at a data privacy integration service that manages data privacy integration for a multiple-application landscape, a first request to start a data privacy integration protocol for a first object instance; sending, by the data privacy integration service, at least one second request to at least one other service, for information regarding which applications of the multiple-application landscape have received a copy of the first object instance; receiving, by the data privacy integration service and from the at least one other service, the information indicating a subset of applications of the multiple-application landscape that have received a copy of the first object instance; creating a work package for the first object instance and the data privacy integration protocol; sending the work package for the first object instance to applications in the subset of applications and not sending the work package to landscape applications not in the subset of applications; receiving work package responses from applications in the subset of applications; determining a data privacy integration protocol result based on the work package responses; and sending, in response to the first request to start the data privacy integration protocol, the data privacy integration protocol result.

Implementations can include one or more of the following features. The first object instance can be a master data object instance representing a first data subject. The at least one other service can include a master data integration service that distributes master data objects to applications in the multiple-application landscape. The master data integration service can maintain master data distribution records which indicate master data object instances have been distributed to which downstream applications in the multiple-application landscape. The master data integration service can determine, based on the master data distribution records and in response to the second request from the data privacy integration service, the information regarding which applications of the multiple-application landscape have received a copy of the first object instance. The at least one other service can include a proxy service that integrates with applications that do not integrate with the master data integration service. The proxy service can be configured to determine which applications, of the applications that do not integrate with the master data integration service, have received a copy of the first object instance. The data privacy integration service can send the second request to the master data integration service but not the proxy service, based on the multiple-application landscape only having applications that integrate with the master data integration service. The data privacy integration service can send the second request to both the master data integration service and the proxy service, based on the multiple-application landscape having both applications that integrate with the master data integration service and at least one application that does not integrate with the master data integration service. The data privacy integration protocol can be an integrated end of purpose protocol in which a respective responding application provides a vote for an object indicating whether the respective responding application can block the object. The data privacy integration protocol can be an aligned purpose disassociation protocol in which a respective responding application provides a vote for an object indicating whether the respective responding application can disassociate a purpose from the object. The at least one other service can include a semantic service that determines, in response to the second request, which applications have received the copy of the first object instance based on semantics of an object identifier of the first object instance. The data privacy integration service can receive a second data privacy integration request for the data privacy integration protocol and determine to send a data privacy integration work package for the second data privacy integration request to all applications in the multiple-application landscape and to not send the second request to the at least one other service.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for integrated data privacy services.

FIGS. 2-4 are swim lane diagrams of example processes for data privacy integration.

FIG. 5 illustrates an example system for monitoring availability of responders of data privacy integration protocols.

FIGS. 6-9 are swim lane diagrams of an example processes for testing a multiple-application landscape by a data privacy integration service.

FIG. 10 is a swim lane diagram of an example process for improving availability of a data privacy integration service.

FIG. 11 is a swim lane diagram of an example process for improving availability of a data privacy integration service.

FIG. 12 is a swim lane diagram of an example process that illustrates problems related to responder application downtime.

FIGS. 13-14 are swim lane diagrams of example processes for scheduling data privacy integration work packages based on anticipated responder availability.

FIG. 15 is a swim lane diagram of an example process for scheduling data privacy integration work packages based on anticipated responder response time.

FIG. 16 is a flowchart of an example method for reducing participants in data privacy integration protocols.

FIG. 17 is a flowchart of an example method for testing data privacy integration protocols.

FIG. 18 is a flowchart of an example method for improving data privacy integration protocols based on application availability.

FIG. 19 is a flowchart of an example method for improving scheduling of data privacy integration protocol processing based on application availability.

### DETAILED DESCRIPTION

An integrated multiple-application landscape can include a data privacy integration (DPI) service that provides various functions for integrating personal data related capabilities of different applications. For example, the DPI service can include protocols related to integrated end-of-purpose processing, integrated personal data retrieval, aligned purpose disassociation, and other protocols. An integrated end-of-purpose protocol can be used to aligned different applications on a point in time when personal data should be blocked from further processing. An integrated personal data retrieval protocol can be used to manage receiving exports of personal data from various applications, so that a common report including personal data concerning a same data subject (e.g., natural person, individual) from multiple applications can be generated. An aligned purpose disassociation protocol can be used to align various applications on when a purpose assignment is removed from a data object. The various DPI protocols can be used on-premise and/or in cloud environments, and can be designed as asynchronous protocols using asynchronous communication between the DPI service and the various applications.

The integrated end-of-purpose, integrated personal data retrieval, and aligned purpose disassociation protocols are described in more detail in U.S. patent application Ser. No. 17/457,797, filed on Dec. 6, 2021 entitled “INTEGRATED END-OF-PURPOSE PROTOCOL FOR MULTIPLE APPLICATIONS” (Attorney Docket No. 22135-1584001/210218US01), U.S. patent application Ser. No. 17/457,811, filed on Dec. 6, 2021 entitled “INTEGRATED PERSONAL DATA RETRIEVAL ACROSS MULTIPLE APPLICATIONS” (Attorney Docket No. 22135-1589001/210217US01), and U.S. patent application Ser. No. 17/457,802, filed on Dec. 6, 2021 entitled “ALIGNED PURPOSE DISASSOCIATION PROTOCOL FOR MULTIPLE APPLICATIONS” (Attorney Docket No. 22135-1586001/210219US01), respectively, the entire contents of each which are hereby incorporated by reference.

Applications may expend a non-trivial amount of resources responding to requests from the DPI service. Different approaches can be used to reduce resource consumption. For example, applications can be grouped into what can be referred to as responder groups, where the DPI service asks applications in different responder groups, in turn, to respond to a request. Applications can be grouped according to a resource-reduction strategy. For example, applications that are more likely to provide a veto vote (e.g., cannot-block, cannot-disassociate purpose) can be put into earlier responder groups, to reduce a likelihood of other applications unnecessarily performing integrated end-of-purpose or aligned purpose disassociation processing, respectively. Other examples include putting applications that are more likely to fail a block application in earlier responder groups, or putting applications that are likely to expend more resources responding to a request in a later responder group. Use of responder groups (and use of the DPI service in general) can involve various types of DPI work packages and work package responses sent by different responders. Responder groups and work packages are described in more detail in U.S. patent application Ser. No. 17/718,770, filed on Apr. 12, 2022 entitled “DATA PRIVACY INTEGRATION SERVICES PROCESSING USING MULTIPLE WORK PACKAGES AND MULTIPLE RESPONDER GROUPS” (Attorney Docket No. 22135-1641001/220136US01), the entire contents of which are hereby incorporated by reference.

Other approaches can be used to improve data privacy integration protocols. For instance, an improvement can be made over solutions that send work packages to responders based on a configured object type. For example, in a solution based on object type, the DPI service can receive a ticket request, for example, for certain a WorkforcePerson object instance who represents a German employee of an organization. The DPI service, when implemented based on object type, may consider as relevant responder applications those applications that are configured as processing WorkforcePerson objects. As such, the DPI service could identify, for a multi-national organization, both a European HR (Human Resources) system and an American HR system as responders, even though the American HR system doesn't handle German WorkforcePerson objects. Accordingly, various types and degrees of inefficiencies can occur (e.g., sending work packages to the American HR system, receiving “not applicable” or “unknown object” messages from the American HR system, the processing in the American HR system itself, etc.).

Moreover, sending requests to all responder applications, including those that do not hold a copy of an object instance, results in involving more responder applications for a ticket than necessary, which can lead to a higher likelihood for a DPI ticket to fail, since more responder applications have a chance to fail to respond before a timeout occurs. In this example, the resources to process the ticket until the timeout occurs are wasted. Additionally, objects may be in an unblocked state for a longer period than is required, which can be interpreted as incompliance in the context of data protection. Furthermore, since objects may remain unblocked for a longer time than necessary, a new transactional process could be started that reference such objects, although the object was earlier considered for blocking.

To improve upon the object type-based solution, an improved DPI service can determine, before sending work packages, relevant responders for a ticket by determining (or receiving) information that indicates which systems likely actually hold a copy of an object instance associated with a DPI request. In some examples, the DPI service may determine systems that might have a copy of the object (e.g., based on information that indicates that those systems have received a copy of the object) and systems that do not (or cannot, based on configurations or knowledge) have a copy of an object. The DPI service can filter, from relevant responders, systems that do not or cannot hold a copy of the object (and keep as relevant responders systems that might have a copy of the object).

Other improvements to the DPI service can relate to improving availability. An important metric for cloud software can be availability. Software-as-a-Service (SaaS) providers may typically be held accountable for making cloud software available (e.g., providing the software in an “up and running” state) so that customers can access and use the software, for example, through the Internet. Technical unavailability of cloud software may lead to contractual penalties and damages and the interruption of customer processes, thus potentially leading to SLA (Service Level Agreement) violations.

In the context of the DPI service, the DPI service can be available in one sense for customers in such a way that a user interface is accessible and the DPI service enables configuration changes, DPI ticket creation and basic ticket handling (e.g., work package preparation and sending for responder applications, accepting responses to such work packages, determining DPI protocol decisions (e.g., which objects are to be blocked or not to be blocked), orchestrate error handling by taking decisions to unblock objects, etc. However, although the DPI service itself may be available and running, the DPI service may not be fully useful for customers if the software applications integrated with the DPI service are not available. For example, although the DPI service can create a ticket and a check work package for a responder application in a responder group, the unavailability of the application can lead to a result, for the master data object(s) affected by the work package, that the ticket cannot be executed successfully (e.g., since a landscape consensus might not be able to be reached without feedback from that application). Application unavailability may occur for a variety of reasons, such as technical unavailability (e.g., application not started or halted, communication issues), programming errors, misconfiguration, scheduled maintenance, or other reasons.

Responder application unavailability can lead to disadvantages on different levels. First, users may be dissatisfied because the action they intended to perform in the system fails. Second, addressing a responder unavailability may consume substantial resources (e.g., to determine whether a failed action should be tried again, to determine whether any configuration in the responder application or in the DPI service is to be changed, etc.). Third, organizations may experience disadvantages or data privacy regulation non-compliance because the organizations cannot block personal data in a timely manner in organizational systems. Fourth, when DPI protocols run without success, resource waste can occur (e.g., computing power, electricity, load on the systems, etc.).

As described below, various approaches can be used to increase overall availability of the DPI service, thus addressing and improving the problems described above. The approaches can be employed to increase a probability that DPI tickets are executed successfully. For example, the approaches can include predicting responder availability and scheduling work packages based on that predicted availability. As another example, predictions can be made regarding certain responders likely needing more time than others to process a work package, and work package handling for those responders can be treated differently than for other responders, to increase a likelihood that those responders successfully process a work package (e.g., before a timeout occurs). In some cases, when some responders are currently down, a prediction engine can predict that those responders are likely to come back online in time to participate in a protocol run, and therefore a decision can be made to continue handling a protocol request based on that prediction (e.g., rather than completely cancelling a DPI ticket). In other cases, even when some responders are down and predicted to remain down, some protocol processing can be performed (e.g., to gather information from responder applications that provide veto votes as to when those applications may next be able to block an object or disassociate a purpose from an object). Such information can be provided to a current requester or a subsequent requester (e.g., to communicate a next likely time point at which a successful protocol run may occur). Other approaches and details are described below.

In general, the measures to improve DPI service availability can contribute to increasing successful executions of DPI protocols (e.g., thus increasing the availability of the protocols themselves). Accordingly, non-effective execution of protocols and corresponding waste of technical resources can be reduced. Additionally, a technical effort can be reduced for data controllers to collect evidence as to why the behavior of the data controller is compliant with data protection laws.

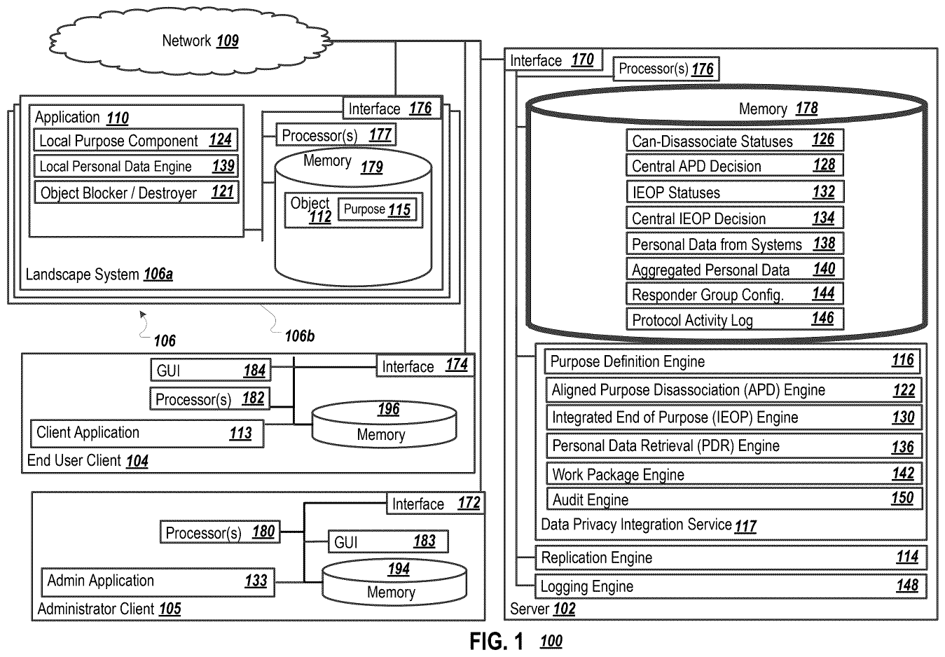

FIG. 1 is a block diagram illustrating an example system 100 for integrated data privacy services. Specifically, the illustrated system 100 includes or is communicably coupled with a server 102, an end-user client device 104, an administrator client device 105, landscape systems 106 (e.g., including a landscape system 106a and a landscape system 106b), and a network 108. Although shown separately, in some implementations, functionality of two or more systems or servers may be provided by a single system or server. In some implementations, the functionality of one illustrated system, server, or component may be provided by multiple systems, servers, or components, respectively. For example, the server 102 includes different engines which may or may not be provided by a single system or server. Furthermore, although the system 100 is illustrated as being configured for handling operations for one organization, the server 102 and included components are configured to handle operations for multiple organizations (e.g., in a multi-tenant fashion). For instance, each organization may be a customer of a software provider that provides the server 102 (and other servers) and implementations of component included in the server 102. The software provider can also provide at least some of the landscape systems 106, which can each also have multi-tenant architectures.

The landscape systems 106 can include multiple systems that exist in a multi-system landscape. An organization can use different systems, of different types, to run the organization, for example. Other types of systems can be used to provide services for end users. The landscape systems 106 can include systems from a same vendor (e.g., the software provider mentioned above) or different vendors. The landscape systems 106 can each include at least one application 110 for performing organizational processes and working with organizational data. Organizational data can include master data objects and transactional objects. For example, the application 110 can process a master data object 112. An end user of the organization can use a client application 113 (which may be a client version of the application 110) on the end-user client device 104 to consume and/or interact with landscape data, including information from the master data object 112. Regarding the handling of master data objects, various best practices can be applied by an organization. For example, the system 100 can be configured so that corresponding master data objects are consistent across all landscape systems 106. For instance, a replication engine 114 can distribute master data to at least some of the landscape systems 106 so that each application 110 that acts on certain master data can perform processing on the same consistent master data. As described in more detail below, an administrator of the organization can use the administrator client device 105 to perform various administration and/or configuration tasks to configure the landscape systems 106 and/or other tools included in the server 102 (or other servers or systems).

For example, various data protection rules and laws may require that data is only processed for specified purposes. The system 100 can implement a purpose requirement by associating purpose information with each object instance (or portion of an object instance). For example, a purpose 115 has been associated with the master data object 112. A purpose definition engine 116 can be included in a DPI service 117 to enable customers to define purposes for processing personal data that are relevant for the customer.

The landscape system 106 can receive the master data object 112 and the associated purpose 115 from the replication engine 114, for example. The DPI service 117 can determine which applications process objects for which purposes. The replication engine 114 can replicate an object with an assigned purpose to a given landscape system 106 when the landscape system 106 processes objects for that purpose. Purpose-based processing can be performed in the landscape system 106, as described in more detail below.

Objects that no longer have any associated productive purposes can be put into a blocked state for a period of time, in accordance with one or more non-productive purposes, for instance by an object blocker/destroyer 121, before being deleted. For instance, while an object instance with no attached purposes may no longer be used for transactions or have any need to be accessed by production systems, the object can be maintained, in a blocked state, for a certain number of days or years, to enable auditing, for example. An authorized service, such as an audit service, may be enabled to access the blocked object, but other production applications or services can be prevented from accessing the blocked object. As another example, for an application that provides both productive functionality and audit functionality, the audit portion of the application can access blocked data but the productive portion of the application cannot access blocked data.

As part of an aligned purpose disassociation (APD) approach, the landscape systems 106 can disassociate a purpose with an object in response to information received from an aligned purpose disassociation engine 122 of the DPI service 117, rather than solely based on a local decision. For example, each landscape system 106 can provide information to the aligned purpose disassociation engine 122. For example, a local purpose component 124 in each landscape system 106 can determine, for each purpose of an object, whether the purpose can be locally disassociated from the object. In some cases, the local purpose component 124 can determine, without consulting other systems, whether a purpose can be locally disassociated from the object. In other cases, the local purpose component 124 may consult other system(s) when performing the local check. For example, if a first system is integrated with a second system and exchanges data with the second system, but the second system is not integrated with the APD protocol, the first system may contact the second system and consider the status of the second system as part of a local status of the first system for the APD protocol. As another example, the second system may be integrated with the APD protocol but the first system may know that specific circumstances within the second system are relevant for the local status of the first system. For example, the first system may know that a purpose that cannot be disassociated from data within the second system may result in the purpose not being able to be disassociated in the first system. As an example, suppose the first system collects expense information that is transferred to the second system and posted as financial data in the second system. The first system may be integrated with the second system (e.g., before the systems became integrated with the APD protocol) in such a way that the first system can ask the second system whether a purpose can be disassociated from the data.

For example, each landscape system 106 can determine a “can-disassociate” status for a requested purpose and object. A can-disassociate status for a respective landscape system 106 can be either an affirmative can-disassociate status that indicates that the landscape system 106 can disassociate a purpose from an object or a negative can-disassociate status that indicates that the landscape system 106 cannot disassociate the purpose from the object. The aligned purpose disassociation engine 122 can collect received can-disassociate statuses 126. The aligned purpose disassociation engine 122 can evaluate the can-disassociate statuses 126 to determine a central aligned disassociate purpose decision 128 regarding disassociating a purpose from an object. The aligned purpose disassociation engine 122 can determine that the central aligned disassociate purpose decision 128 is to disassociate the purpose from the object if no landscape system 106 is unable to disassociate the purpose from the object. The aligned purpose disassociation engine 122 can determine that the central aligned disassociate purpose decision 128 is to not disassociate the purpose from the object if at least one landscape system 106 is unable to disassociate the purpose from the object. The aligned purpose disassociation engine 122 can provide the central aligned disassociate purpose decision 128 to each landscape system 106. The local purpose component 124 can disassociate the purpose from the object in response to receiving the central aligned disassociate purpose decision 128, if the central aligned disassociate purpose decision 128 is in fact to disassociate the purpose from the object.

The object blocker/destroyer 121 can block an object (e.g., from all production processing) when no productive purposes are associated with the object (e.g., after all productive purposes have been disassociated), according to one or more retention policies. An object can be blocked, rather than destroyed, if one or more retention policies associated with one or more non-productive purposes state that the object is to be maintained for access, outside of productive processing, only by authorized users. The object blocker/destroyer 121 can determine to destroy a blocked object in response to determining that all applicable retention reasons have expired. Object destruction decisions and actions can occur locally and independently in each landscape system 106. For example, each application 110 can determine locally whether a blocked object is to be destroyed. For instance, the application 110 can determine to destroy an object (e.g., a master data object) when no purposes are associated with the object, no transactional data references the object, and no retention policy currently applies to the object. In response to an object destruction decision, the object blocker/destroyer 121 can destroy the object. As described below, object blocking can be aligned across systems, so that, e.g. master data is blocked in all systems at substantially a same point in time to ensure that a first system does not create new transactional data referencing the master data where the new transactional data is replicated to a second system in which the master data had already been blocked.

In some implementations, an iEoP (Integrated End of Purpose) engine 130 of the DPI service 117 is used instead of or in addition to the APD engine 122. The iEoP engine 130 can send EoP queries to each landscape system 106 and receive EoP statuses 132 from the local purpose components 124 of different landscape systems regarding ability to block or delete a particular master data object. The iEoP engine 130 can evaluate the EoP statuses 132 to generate a central EOP decision 134. If a consensus is reached regarding ability to block an object, the iEoP engine 130 can distribute aligned block commands to trigger an aligned blocking of the object across the landscape systems 106. The iEoP engine 130 can also orchestrate integrated unblocking, when unblocking is required due to blocking failure in one or more systems, or for other reasons.

As mentioned, a data subject can have a right to request personal data stored associated with the data subject. The data subject (or the data controller, on behalf of the data subject) can initiate a personal data request from any of the landscape systems 106. For example, the data subject may submit a request using a user interface of the client application 113, with the request being received by the application 110 that handles requests from the client application 113. The application 110 can forward the request to a personal data retrieval (PDR) engine 136 of the DPI service 117. Accordingly, any application within the landscape that is integrated with the DPI service 117 can request a report that, when generated, includes personal data automatically obtained by the DPI service from all of the other applications in the landscape. The data subject, therefore, can trigger a personal data request, in any one of the applications, rather than having to request from all of the applications. The PDR engine 136 automatically requests and receives personal data 138 from respective local personal data engines 139 in different landscape systems 106. The PDR engine 136 then creates aggregated personal data 140 and provides the aggregated personal data 140 to the data subject in response to the request, as a unified and uniform data report. In addition to the APD engine 122, the iEoP engine 130, and the PDR engine 136, the DPI service 117 can include or provide other data privacy integration services.

A work package engine 142 can be used to split requests into multiple work packages. As mentioned above, the DPI service 117 can send requests (e.g., work packages) to applications according to responder group configurations 144.

The work package engine 142, or more generally, the DPI service 117, can perform other approaches for strategic creation and scheduling of work packages, to increase a likelihood of success for protocols runs (e.g., where success can be defined as completing a ticket execution without aborting ticket execution due to unavailability/lack of response by responders). For example, the DPI service 117 can leverage a protocol activity log 146 generated by a logging engine 148. The logging engine 148 can log protocol requests, protocol handling, landscape system 106 availability, landscape system 106 response time, landscape system 106 failures to respond, etc.

In some cases, the work package engine 142 can analyze information in the protocol activity log 146 such as analyzing a response time per landscape system 106 to control a number of work packages sent in a given time period), size of sent work packages, and/or a number of overall objects sent per time period to certain landscape systems 106. For example, one system may have capacity to handle N work packages per day, and the work package engine 142 can avoid sending more than N work packages to that system in a given day. As another example, another system may be able to handle work packages up to a size of M objects, and the work package engine 142 can avoid sending a work package with more than M objects to that system. As yet another example, a system may be able to handle X objects total per day, and the work package engine 142 can handle sending work packages to that system so that all work packages in a given day sent to that system do not include a total of more than X object identifiers. In general, to reduce a likelihood that a work package runs into a timeout, the work package engine 142 may control the load on the different landscape systems 106. For example, the work package engine 142 may determine that for landscape systems that need more time to respond to a work package, work package characteristics (e.g., how many work packages are created for that landscape system 106 per time unit, the size of work packages with respect to a count of objects included in work packages, etc.) can be adjusted. As other examples, the work package engine 142 can perform other various types of analysis (in some cases using AI/ML learning) to identify preferred work package scheduling for certain landscape systems 106 based on the protocol activity log (and predictions that may be generated from such log information) for increasing a likelihood of successful protocol runs or at least protocol runs that provide useful information.

Other examples can include the work package engine 142 considering work package type and in some cases, a set of linear equations. For example, the work package engine 142 can determine (or otherwise know or be informed) that a certain system might consume a certain amount more resources to perform, for example, an end-of-purpose check than to block an object. The work package engine 142 can, for example, determine how many objects a system generally blocks in a given day and then determine how many check work packages can be sent to the system in a given day without overburdening the system. In some cases, the work package engine 142 can treat blocking operations as more time critical than checking operations (e.g., because other systems may receive a block work package roughly at a same time, and blocking faster by a given system may reduce a likelihood of blocking inconsistencies and subsequent unblocking if one or more systems fail in blocking). Accordingly, the work package engine 142 may determine a number of check work packages to send to a given system based on an amount of resources left over after considering resources that may be used for blocking operations.

An audit engine 150 can provide auditing functionality based on information in the protocol activity log 146. The protocol activity log 146 can include, for example, information that indicates, for example, timeframes and other pertinent information (e.g., work package download history, other event information) for when certain landscape systems 106 were not available, and other information that may have influenced whether the DPI service 117 had rejected the creation of a DPI ticket or modified DPI processing in other ways, based on real time conditions. Such information may be used help a data controller to prove, if necessary, for example, that blocking of personal data was intended by the data controller but that the blocking was postponed for technical reasons. The data controller may use such information, if required, as an indicator of following data protection legislation with regards to the blocking of personal data. For example, the audit engine 150 can provide access to information in the protocol activity log 146 (e.g., in the administrative application 133), to enable audit capabilities for the data controller.

As an example, the DPI service 117 can determine, for a particular ticket whether the ticket is accepted, and with which properties. The logging engine 148 can log the ticket creation decision and relevant information that led to the decision (e.g., assumptions about landscape system availability or non-availability during the expected time of ticket execution) in the protocol activity log 146. When a ticket is flagged as recommended for rejection, the DPI service 117 can enable a requester to decide whether the ticket should be withdrawn or started. The requester can inform the DPI service 117 about the requester decision and the logging engine 148 can record the requester decision.

In some cases, an administrator (e.g., a user of the administrator client device 105) may be provided a user interface (e.g., in the administrative application 133) that displays information about the availability of landscape systems 106. From such monitoring information, an ideal responder group configuration may be proposed to or for the DPI service 117 by the administrator, thus increasing DPI efficiency and in some cases availability. In some cases, the administrator may send requests to administrators of certain landscape systems 106 to take necessary actions to increase the availability of those systems at specific points in time, e.g., by changing certain configurations.

In some implementations, the DPI service 117 provides warning information to requesters about landscape system 106 unavailability and possible ticket processing failure. For example, the DPI service 117 may respond to a create ticket request by a requester with a specific code or message that indicates a warning with a semantic that the ticket may likely not be successfully executed due to known or predicted unavailability issues of landscape system(s) 106. In some implementations, the requester may suppress such a warning indication by using a specific parameter when creating a ticket, such as a parameter of “suppressUnavailabilityWarning”. The requester may explicitly confirm an intention to nevertheless start the ticket even if a warning occurs by setting, for example, an “enforceTicketStart” parameter on a ticket start request (which can be sent to the DPI service 117 after a ticket is created and after the requester receives a warning). The enforce ticket start parameter can have an effect that a ticket is executed even though not all landscape systems 106 may be available during the ticket execution. For example, the requester application (or a user using the requester application) may have special knowledge that a landscape system currently unavailable will be available again soon, or the requester may have certain reasons for trying to execute the ticket for compliance reasons.

As mentioned above, in some cases, the DPI service 117 can determine which landscape systems 106 may likely store a copy of an object instance associated with a request (e.g., based on information that indicates that the landscape system 106 has received a copy of the object), and the work package engine 142 can create work packages only for those landscape systems 106 (and not for other landscape systems 106 that have not received a copy of the object instance). For instance, the replication engine 114 can consider object attributes. For example, a master data orchestration portion of the replication engine 114 can decide, on an attribute level, which purposes should be associated with a master data object. For instance, a WorkforcePerson object instance with a field “COUNTRY=GERMANY” may be associated with a purpose “EMPLOYMENT GERMANY”. The replication engine 114 can use such information and provide the WorkforcePerson master data object only to downstream landscape systems 106 that should receive WorkforcePerson master data objects with purpose “EMPLOYMENT GERMANY”. Accordingly, only some landscape systems 106 may hold a certain WorkforcePerson object instance. As described in more detail below, the DPI service 117 can, as part of ticket processing of a ticket for a given object instance, query the replication engine 114 for information regarding which landscape systems 106 hold a copy of the object instance and then efficiently only send DPI work packages to those landscape systems 106.

As used in the present disclosure, the term “computer” is intended to encompass any suitable processing device. For example, although FIG. 1 illustrates a single server 102, a single end-user client device 104, a single administrator client device 105, the system 100 can be implemented using a single, stand-alone computing device, two or more servers 102, or multiple client devices. Indeed, the server 102 and the client devices 104 and 105 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server 102 and the client devices 104 and 105 may be adapted to execute any operating system or runtime environment, including Linux, UNIX, Windows, Mac OS®, Java™, Android™, iOS, BSD (Berkeley Software Distribution) or any other suitable operating system. According to one implementation, the server 102 may also include or be communicably coupled with an e-mail server, a Web server, a caching server, a streaming data server, and/or other suitable server.

Interfaces 170, 172, 173, and 174 are used by the server 102, the end-user client device 104, the landscape system 106a, and the administrator client device 105, respectively, for communicating with other systems in a distributed environment—including within the system 100—connected to the network 108. Generally, the interfaces 170, 172, 173, and 174 each comprise logic encoded in software and/or hardware in a suitable combination and operable to communicate with the network 108. More specifically, the interfaces 170, 172, 173, and 174 may each comprise software supporting one or more communication protocols associated with communications such that the network 108 or interface's hardware is operable to communicate physical signals within and outside of the illustrated system 100.

The server 102 includes one or more processors 176. Each processor 176 may be a central processing unit (CPU), a blade, an application specific integrated circuit (ASIC), a field-programmable gate array (FPGA), or another suitable component. Generally, each processor 176 executes instructions and manipulates data to perform the operations of the server 102. Specifically, each processor 176 executes the functionality required to receive and respond to requests from the end-user client device 104, for example. Similarly, each landscape system 106 includes one or more processors 177. Each processor 177. Each processor 177 executes instructions and manipulates data to perform the operations of the respective landscape system 106.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, ABAP (Advanced Business Application Programming), ABAP OO (Object Oriented), any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The server 102 includes memory 178. In some implementations, the server 102 includes multiple memories. The memory 178 may include any type of memory or database module and may take the form of volatile and/or non-volatile memory including, without limitation, magnetic media, optical media, random access memory (RAM), read-only memory (ROM), removable media, or any other suitable local or remote memory component. The memory 178 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server 102. Similarly, each landscape system 106 includes memory 179. The memory 179 may store various objects or data associated with the purposes of the landscape system 106.

The end-user client device 104 and the administrator client device 105 may each be any computing device operable to connect to or communicate in the network(s) 108 using a wireline or wireless connection. In general, each of the end-user client device 104 and the administrator client device 105 comprises an electronic computer device operable to receive, transmit, process, and store any appropriate data associated with the system 100 of FIG. 1. Each of the end-user client device 104 and the administrator client device 105 can include one or more client applications, including the client application 113 or an administrative application 133, respectively. A client application is any type of application that allows a client device to request and view content on the client device. In some implementations, a client application can use parameters, metadata, and other information received at launch to access a particular set of data from the server 102. In some instances, a client application may be an agent or client-side version of the one or more enterprise applications running on an enterprise server (not shown).

The client device 104 and the administrator client device 105 respectively include processor(s) 180 or processor(s) 182. Each processor 180 or 182 included in the end-user client device 104 or the administrator client device 105 may be a central processing unit (CPU), an application specific integrated circuit (ASIC), a field-programmable gate array (FPGA), or another suitable component. Generally, each processor 180 or 182 included in the end-user client device 104 or the administrator client device 105 executes instructions and manipulates data to perform the operations of the end-user client device 104 or the administrator client device 105, respectively. Specifically, each processor 180 or 182 included in the end-user client device 104 or the administrator client device 105 executes the functionality required to send requests to the server 102 and to receive and process responses from the server 102.

Each of the end-user client device 104 and the administrator client device 105 is generally intended to encompass any client computing device such as a laptop/notebook computer, wireless data port, smart phone, personal data assistant (PDA), tablet computing device, one or more processors within these devices, or any other suitable processing device. For example, the end-user client device 104 and/or the administrator client device 105 may comprise a computer that includes an input device, such as a keypad, touch screen, or other device that can accept user information, and an output device that conveys information associated with the operation of the server 102, or the client device itself, including digital data, visual information, or a GUI 183 or a GUI 184, respectively.

The GUI 183 and the GUI 184 each interface with at least a portion of the system 100 for any suitable purpose, including generating a visual representation of the client application 113 or the administrative application 133, respectively. In particular, the GUI 183 and the GUI 184 may each be used to view and navigate various Web pages. Generally, the GUI 183 and the GUI 184 each provide the user with an efficient and user-friendly presentation of business data provided by or communicated within the system. The GUI 183 and the GUI 184 may each comprise a plurality of customizable frames or views having interactive fields, pull-down lists, and buttons operated by the user. The GUI 183 and the GUI 184 each contemplate any suitable graphical user interface, such as a combination of a generic web browser, intelligent engine, and command line interface (CLI) that processes information and efficiently presents the results to the user visually.

Memory 194 and memory 196 respectively included in the end-user client device 104 or the administrator client device 105 may each include any memory or database module and may take the form of volatile or non-volatile memory including, without limitation, magnetic media, optical media, random access memory (RAM), read-only memory (ROM), removable media, or any other suitable local or remote memory component. The memory 194 and the memory 196 may each store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the respective client device.

There may be any number of end-user client devices 104 and administrative client devices 105 associated with, or external to, the system 100. Additionally, there may also be one or more additional client devices external to the illustrated portion of system 100 that are capable of interacting with the system 100 via the network(s) 108. Further, the term “client,” “client device,” and “user” may be used interchangeably as appropriate without departing from the scope of this disclosure. Moreover, while client device may be described in terms of being used by a single user, this disclosure contemplates that many users may use one computer, or that one user may use multiple computers.

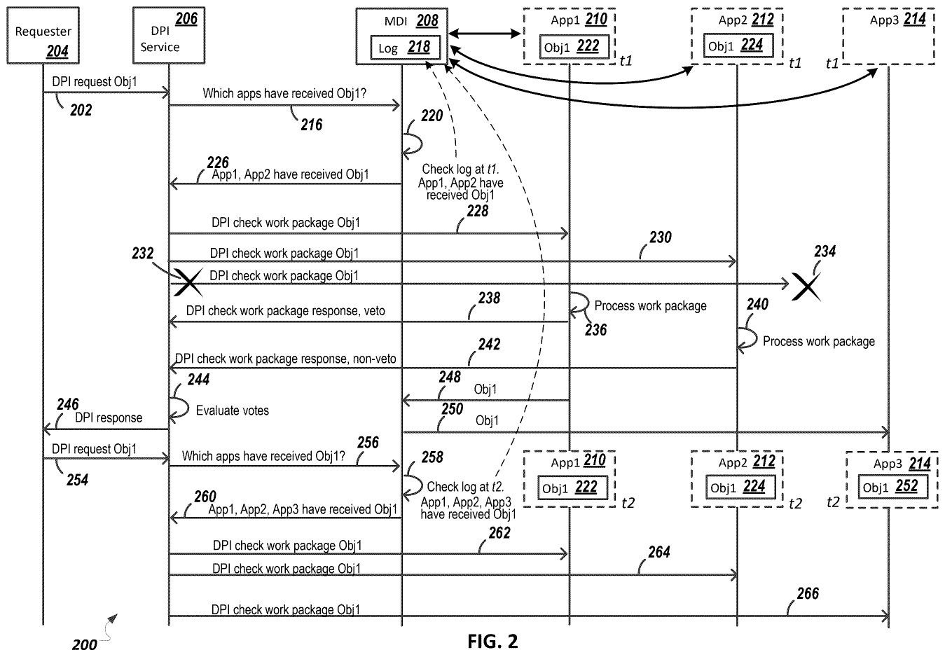

FIG. 2 is a swim lane diagram of an example process 200 for data privacy integration. At 202, a requester 204 sends a DPI request for an Obj1 object to a DPI service 206. The DPI request can be a request to start a ticket for the iEoP or APD protocols, for example.

The DPI service 206 can be connected to an MDI service 208. Rather than send a DPI work package to all potential responders (e.g., all of a first application 210, a second application 212, and a third application 214), the DPI service 206 can, at 216, send a request to the MDI service 208 that asks the MDI service 208 which responders have received a copy of the Obj1 object. The MDI service 208 can, for example, maintain a log 218 that stores information recording which downstream applications have received copies of which object instances.

At 220, the MDI service 208 can check the log 218 to determine which responders have received a copy of the Obj1 object. The log 218 at that time can reflect a state of which applications have which objects at a time point t1. The MDI service 208 can determine, based on querying the log 218 at the time point t1, that the first application 210 and the second application 212 have received respective copies 222 and 224 of the Obj1 object, but that the third application 214 has not received a copy of the Obj1 object. At 226, the MDI service 208 can respond to the DPI service 206 with information indicating that the first application 210 and the second application 212 may each have copies of the Obj1 object.

Based on the response from the MDI service 208, the DPI service 206 can send a DPI work package 228 or 230 (e.g., an iEoP check work package or an APD check work package) to the first application 210 or the second application 212, respectively. The DPI service 206 does not send a DPI work package to the third application 214, as illustrated by symbols 232 and 234, since the DPI service 206 was informed that the third application 214 has not received a copy of the Obj1 object.

At 236, the first application 210 processes the DPI work package 228. For example, the first application 210 can determine, when the DPI work package 228 is an iEoP check work package, that the first application 210 cannot block the Obj1 object. As another example, when the DPI work package 228 is an APD check work package, the first application 210 can determine that the first application 210 cannot disassociate a specified purpose from the Obj1 object (e.g., where the purpose is specified in the request sent by the requester 204). At 238, the first application 210 responds to the DPI work package 228 with a veto vote (e.g., cannot block object, cannot disassociate purpose from object).

At 240, the second application 212 processes the DPI work package 230. For example, the second application 212 can determine, when the DPI work package 230 is an iEoP check work package, that the second application 212 can block the Obj1 object. As another example, when the DPI work package 230 is an APD check work package, the second application 212 can determine that the second application 212 can disassociate a specified purpose from the Obj1 object. At 242, the second application 212 responds to the DPI work package 230 with a non-veto vote (e.g., can block object, can disassociate purpose from object).

At 244, the DPI service 206 can evaluate votes received from responders sent in response to the DPI work package. For example, the DPI service 206 can determine that a consensus has not been reached (since at least the first application 210 has responded with a veto vote). Therefore, the DPI service 206 can complete processing of the DPI request sent by the requester 204. At 246, the DPI service 206 can send a DPI response to the requester 204, indicating that a consensus vote was not reached (and that therefore the Obj1 object cannot currently be blocked in the landscape or that a specified purpose cannot be disassociated from the Obj1 object.

In some implementations, if the DPI service 206 does determine that the object is to be blocked, the DPI service 206 can, in addition to sending block commands, send a second request to the MDI service 208 for the MDI service 208 to (1) not distribute the object further (e.g., to lock the distribution process of this process to avoid a potential race condition and potential inconsistencies if object distribution would occur while the data privacy integration process is running); and (2) verify, that since the request sent at 216 that no further responders have received the object. After the MDI service 208 has locked the distribution of the object, the DPI service 206 can later inform the MDI service 208 when the lock can be removed, such as when the blocking process has completed (either successfully or unsuccessfully). In some implementations, the request sent at 216 can include or correspond to a request to lock distribution of the object, and the DPI service 206 can later inform the MDI service 208 when the lock can be removed.

At some point after the t1 time point, other distributions of the Obj1 object can occur. For example, at 248, the first application 210, which may be an upstream application to the third application 214, can send a copy of the Obj1 object copy 222 to the MDI service 208 (e.g., in response to attribute(s) changing in the Obj1 object copy 222 at the first application 210) to enable the MDI service 208 to later distribute the Obj1 object to the third application 214 (e.g., based on the object now matching a filter criteria used for distribution of objects to the third application 214). Other examples for redistribution of the object to the third application 214 can include a configuration change occurring in the MDI service 208 itself. At 250, the MDI service 208 distributes the Obj1 object copy to the third application 214, for storage at the third application 214, as illustrated by an Obj1 object copy 252 in the third application 214.

The requester 204 (or another requester) can send another DPI request. For example, at 254, the requester 204 sends a DPI request for the Obj1 object to the DPI service 206. At 256, the DPI service 206 can send a request to the MDI service 208 that asks the MDI service 208 which responders have received a copy of the Obj1 object.

At 258, the MDI service 208 can check the log 218 to determine which responders have received a copy of the Obj1 object. The log 218 at that time can reflect a state of which applications have which objects at a time point t2. The MDI service 208 can determine, based on querying the log 218 at the time point t2, that each of the first application 210, the second application 212, and the third application 214 have received a copy of the Obj 1 object. At 260, the MDI service 208 can respond to the DPI service 206 with information indicating that the first application 210, the second application 212, and the third application 214 each have received copies of the Obj1 object.

Based on the response from the MDI service 208, the DPI service 206 can send a DPI work package 262, 264, or 266 to the first application 210, the second application 212, or the third application 214, respectively. Each application can process and respond to a respective work package. As with handling of the previous DPI request, only applications that have a copy of the Obj1 object receive and process the work package, thereby avoiding unnecessary sending and initial examination of the work package to and by responders who have not received a copy of the object, respectively.

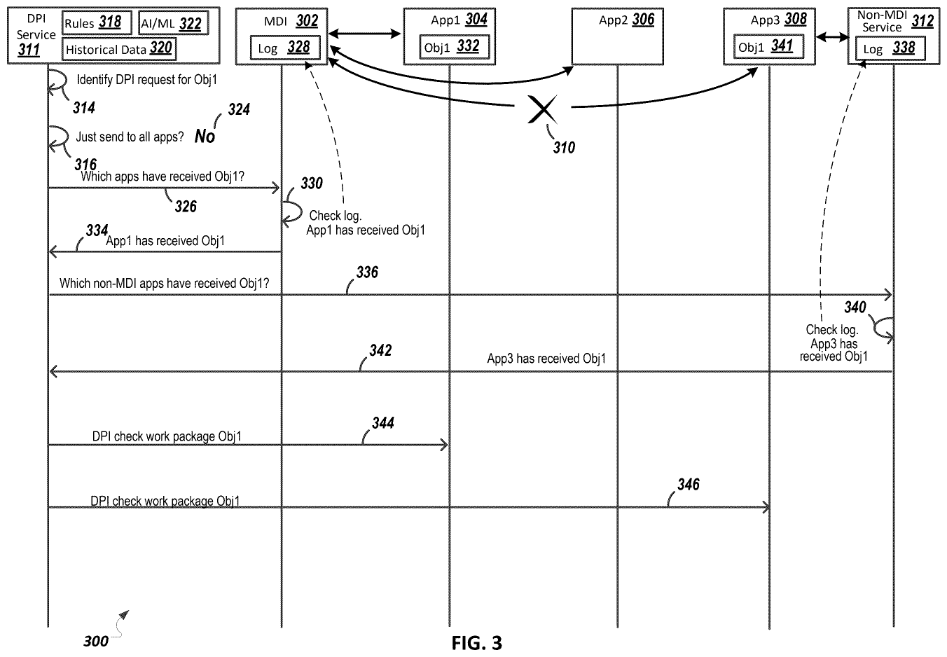

FIG. 3 is a swim lane diagram of an example process 300 for data privacy integration. In some cases, some applications (e.g., legacy applications) may not integrate with an MDI service 302. For example, although a first application 304 and a second application 306 are integrated with the MDI service 302 (e.g., as illustrated by respective arrows between those applications and the MDI service 302), a third application 308 is not integrated with the MDI service 302 (e.g., as illustrated by a symbol 310). In such examples, a DPI service 311 can communicate with a non-MDI service 312 which has knowledge of which non-MDI-integrated applications have received which instances of which objects. In some implementations, the DPI service 311 can communicate directly with and query non-MDI-integrated applications.

At 314, the DPI service 311 identifies a DPI request (e.g., sent by a requester) for an Obj1 object. At 316, in some implementations, the DPI service 311 can perform a check to determine whether to 1) determine which applications have received a copy of the Obj1 object and send a DPI work package to only those responders; or 2) just send a DPI work package to all responders. The DPI service 311 can predict which of option 1) or 2) may be more efficient in terms of time and computing resources, for example. For instance, the DPI service 311 may determine, based on rules 318, historical data 320, and/or using an AI/ML model 322, whether sending a DPI work package to all responders or querying the MDI service 302 and the non-MDI service 312 for applications that store the object and then sending a DPI work package to a potential subset of applications is likely to be more efficient. In this example, the DPI service 311 has determined a result 324 of No (e.g., meaning do not just send to all applications but rather query the MDI service 302 and the non-MDI service 312 for responders who have received the Obj1 object). Although a check done at step 316 is described in this example as potentially involving aspects of both the MDI service 302 and the non-MDI service 312, a similar check can be performed, such as for the process 200, when the landscape includes just an MDI service and not another queryable service.

At 326, the DPI service 311 can send a request to the MDI service 302 that asks the MDI service 302 which responders have received a copy of the Obj1 object. The MDI service 302 can, for example, maintain a log 328 that stores information recording which downstream applications have received copies of which object instances. At 330, the MDI service 302 can check the log 328 to determine which responders have received a copy of the Obj1 object. The MDI service 302 can determine, based on querying the log 328, that the first application 304 has received a copy 332 of the Obj1 object but that the second application 306 has not received a copy of the Obj1 object. The MDI service 302 has no knowledge of whether the third application 308 has received a copy of the Obj1 object, since the third application 308 is not integrated with the MDI service 302. At 334, the MDI service 302 can respond to the DPI service 311 with information indicating that the first application 304 has received a copy of the Obj1 object.

At 336, the DPI service 311 can send a request to the non-MDI service 312 that asks the non-MDI service 312 which non-MDI-integrated applications have received a copy of the Obj1 object. The non-MDI service 312 can, for example, maintain a log 338 that stores information recording which non-MDI-integrated applications have received copies of which object instances. At 340, the non-MDI service 312 can check the log 338 to determine which non-MDI-integrated applications have received a copy of the Obj1 object. The non-MDI service 312 can determine, based on querying the log 338, that the third application 308 has received a copy 341 of the Obj1 object. The non-MDI service 312 can be connected to other applications other than the third application 308. At 342, the non-MDI service 312 can respond to the DPI service 311 with information indicating that the third application 308 has received a copy of the Obj1 object. In some examples, the non-MDI service 312 and/or the MDI service 302 can determine which applications have received the copy of a given object instance based on semantics of an object identifier of the object instance. For instance, object identifiers (or portion(s) of an object identifier) that have are within a certain numeric, alphanumeric, or alphabetic range or that have some other pattern may, based on configurations in the landscape, be received by certain applications.

Based on the responses from the non-MDI service 312 and the MDI service 302, the DPI service 311 can send a DPI work package 344 or 346 (e.g., an iEoP check work package or an APD check work package) to the first application 304 or the third application 308, respectively, without sending a DPI work package to the second application 306.

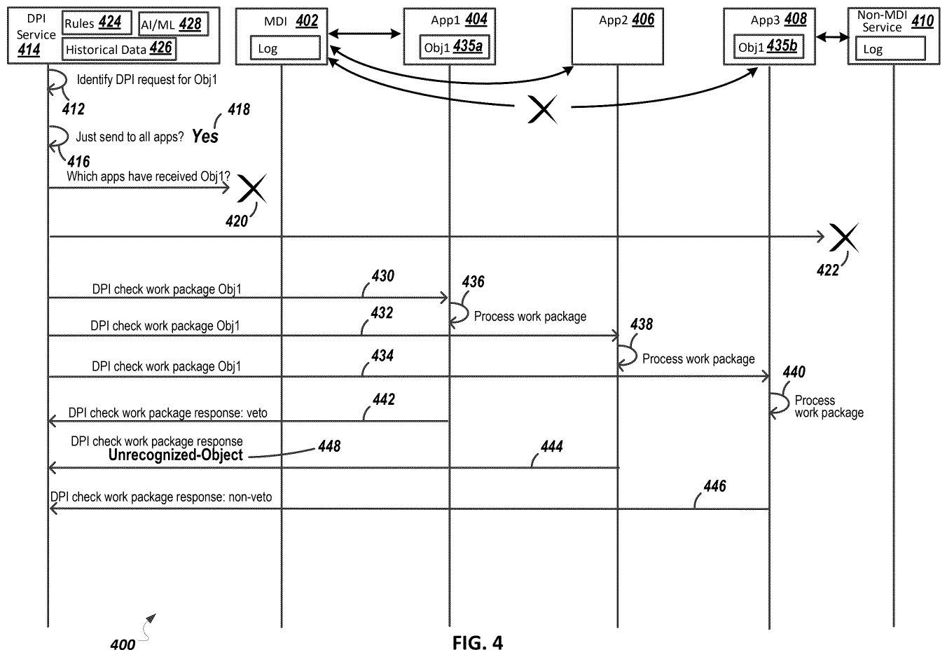

FIG. 4 is a swim lane diagram of an example process 400 for data privacy integration. Similar to the example of FIG. 3, for the process 400, an MDI service 402 is integrated with a first application 404 and a second application 406 but not a third application 408. A non-MDI service 410 is connected to the third application 408.

At 412, a DPI service 414 identifies a DPI request (e.g., sent by a requester) for an Obj1 object. At 416, the DPI service 414 performs a check to determine whether to 1) determine which applications have received a copy of the Obj 1 object and send a DPI work package to only those responders; or 2) just send a DPI work package to all responders. In this example, the DPI service 414 determines a result 418 of Yes (e.g., meaning to just send a DPI work package to all responders rather than determining which responders have received a copy of the Obj1 object). Accordingly, as illustrated by symbols 420 and 422, respectively, the DPI service does NOT send a query to either the MDI service 402 or the non-MDI service 410 inquiring as to which applications have received the Obj1 object.

As described above, the DPI service 414 can predict, based on rules 424, historical data 426, and/or using an AI/ML model 428, whether 1) sending a DPI work package to all responders or 2) querying the MDI service 402 and the non-MDI service 410 for applications that have received the object and then sending a DPI work package to a potential subset of applications is likely to be more efficient. In this example, the DPI service 414 may determine that querying both the MDI service 402 and the non-MDI service 410 may be more costly (e.g., in terms of time and/or computing resources) than simply sending a DPI work package to all responders. In general, the DPI service 414 (or more particularly, the AI/ML model 428) can determine which option is more efficient based on various types of rules 424 and various types of historical data 426 (e.g., responder response times, responder availability, past types of DPI requests and results), as well as particulars of a current DPI request (e.g., which object, which type of object, how many objects in a ticket, current conditions in the landscape (e.g., network conditions, responder availability indications), etc.

Based on the result 418, the DPI service 414 can send a DPI work package 430, 432, or 434 (e.g., an iEoP check work package or an APD check work package) to each the first application 404, the second application 406, or the third application 408, respectively, despite only the first application 404 and the third application 408 having received Obj1 object copies 435a or 435b, respectively, and the second application 406 not having received an Obj1 object copy.

At 436, 438, and 440, respectively, the first application 404, the second application 406, or the third application 408 each process a respective received DPI work package. At 442, 444, and 446, respectively, the first application 404, the second application 406, or the third application 408 each send a respective DPI work package response to the DPI service 414. The DPI work package response sent by the first application 404 indicates a veto vote (e.g., cannot block object, cannot disassociate purpose from object) and the DPI work package response sent by the third application 408 indicates a non-veto vote (e.g., can block object, can disassociate purpose from object). The DPI work package response sent by the second application 406 includes an indication 448 that indicates that the second application 406 does not recognize (e.g., does not have a copy) of the Obj1 object. In some cases, the second application 406 can send a non-veto vote instead of or in addition to the indication 448. The DPI service 414 can determine whether a consensus vote occurs for the Obj1 without taking into account the vote/response sent by the second application 406 (e.g., since an unrecognized response or a non-veto vote won't block an otherwise consensus vote from occurring). In some cases, the second application 406 may have initially received the object but may have subsequently deleted the object (e.g., perhaps due to a misconfiguration (e.g., blocking and deleting without receiving a specific command to do so from the DPI service 414).

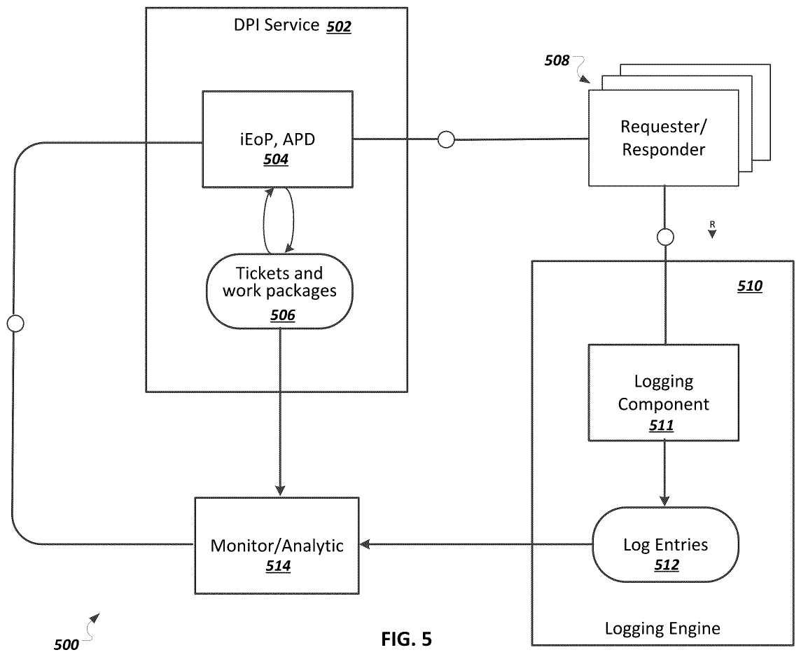

FIG. 5 illustrates an example system 500 for monitoring availability of responders of data privacy integration protocols. A DPI service 502 includes, for example, an iEoP or APD engine 504 that can process DPI data such as iEoP or APD tickets and work packages 506. The DPI service 502 can communicate with various applications (e.g., requesters/responders 508). That is, a given application may have a role of a requester and/or responder (although some applications may only have one of those roles). The DPI protocols can work best when all responders are available to respond to DPI requests. However, certain situations can affect responder availability, as described above, such as planned or unplanned responder downtime, network conditions, or other factors.

A logging engine 510 can be installed in a landscape that includes a logging component 511 that logs information (e.g., as log entries 512) that indicates responder responses, responder response time, and failures to respond to DPI requests over time. A monitor/analytic engine 514 can analyze the log entries 512 in various ways, as described in examples below, to improve efficiency of DPI protocols, based on responder availability, predicted availability, predicted return to an uptime status, etc. Although shown as outside of the DPI service 502 and the logging engine 510, in some examples, some or all portions of the monitor/analytic engine 514 can reside in the DPI service 502 or the logging engine 510.

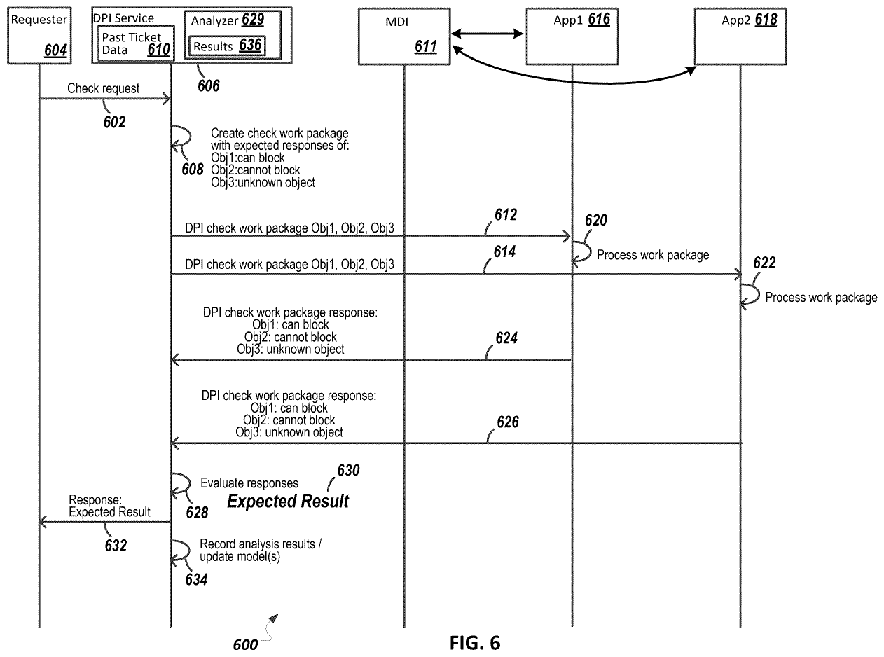

FIG. 6 is a swim lane diagram of an example process 600 for testing a multiple-application landscape by a data privacy integration service. At 602, a requester 604 sends a check request to a DPI service 606 requesting the DPI service 606 to initiate a check to test correctness of a landscape for which the DPI service 606 provides data privacy integration. Correctness of the landscape can correspond to applications being available and responding in expected ways, for instance.

At 608, the DPI service 606 creates a test work package that includes a set of objects for which the DPI service 606 has determined an expected result if the objects are sent in a check work package. For example, the test work package includes Obj1, Obj2, and Obj3 objects for which expected results are can block, cannot block, and unknown object, respectively. An administrator can identify the Obj1, Obj2, and Obj3 objects, for example. The DPI service 606 can identify the test objects and the expected results from recent data in a past ticket data repository 610, for example. As another example, the DPI service 606 can receive and evaluate information from another system or service (e.g., an MDI service 611) that enables the DPI service 606 to determine expected responses for a set of test objects. As another example, the DPI service 606 can prompt an administrator for a set of object identifiers of objects for which expected results are known.

At 612 and 614, the DPI service 606 sends the test work package including Obj1, Obj2, and Obj3 objects to a first application 616 and a second application 618, respectively. At 620 and 622, the first application 616 and the second application 618 process the work package, respectively, including determining a check status for each of the Obj1, Obj2, and Obj3 objects. At 624 and 626, the first application 616 and the second application 618 send a check work package response to the DPI service 606, respectively. Each check package response includes expected results for the Obj1, Obj2, and Obj3 objects (e.g., can block, cannot block, unknown object, respectively).

At 628, an analyzer 629 of the DPI service 606 evaluates the check work package responses from all responders and determines an overall result 630 of “expected result” (e.g., since each responder returned respective expected results). At 632, the DPI service 606 responds to the requester 604 with an indication of the overall result 630. At 634, the DPI service 606 records the overall result 630 (and possibly more detailed analysis information) in a results store 636 of the DPI service 606.

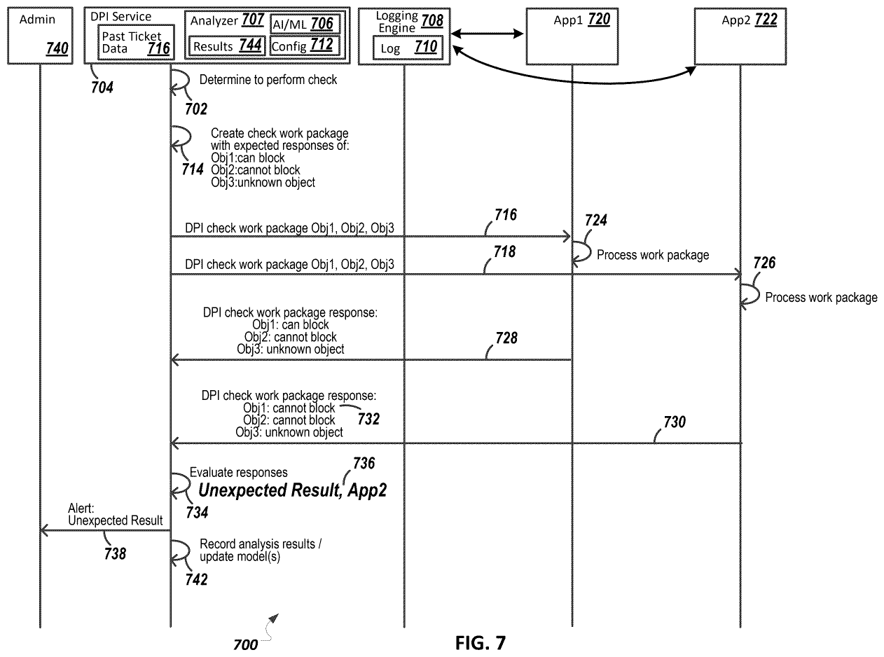

FIG. 7 is a swim lane diagram of an example process 700 for testing a multiple-application landscape by a data privacy integration service. At 702, a DPI service 704 makes a determination to perform a check of the multiple-application landscape.

For example, an AI/ML engine 706 of an analyzer 707 of the DPI service may determine that the check is to be triggered. The DPI service 704 may be implemented as a cloud application/service, for example, and different instances of responder applications may generally be similar between different cloud landscapes of different customers. Therefore, the AI/ML engine may use a predictive maintenance type of approach to determine when to trigger a check for a given landscape of a particular customer. For example, a logging engine 708 may record, in a log 710, information regarding DPI ticket failures, such as responder applications not responding and other failures. The logging engine 708 can record relevant state data in the log 710, which can include current configuration data 712 relevant to the landscape of the customer at the time of failure. The logging engine 708 can log, over time, changes to the configuration data 712 that occur over time, including version updates of the DPI service 704 and any supporting services or systems, as well as changes to requester and/or responder applications. Similar information can be logged for each landscape (e.g., for each customer).

The logging engine 708 can, over time, identify and record any issues with DPI processes or protocols in one or more customer landscapes. Issues can include a higher than usual number of work packages having timeout issues, certain responder applications are no longer responding, work packages are not being fetched anymore from certain responders, etc. The DPI service 704 can determine that a same type of issue has occurred in multiple customer landscapes.

The analyzer 707 can determine, from logged information, that an association occurs between an issue and change(s) that have occurred in the affected landscape(s). For example, the AI/ML engine 706 can determine, in real time, for the multiple-application landscape of FIG. 7, that a same change (e.g., in configuration data 712 or other data) has recently occurred in the multiple-application landscape, thus leading to the determination at step 702 to perform a check by the DPI service 704 in this particular landscape.

Accordingly, a test can be performed for the customer of this landscape which has similar characteristics as other landscapes for which issues have occurred. This predictive maintenance type of approach may particularly address changes that occur over time. For example, suppose a specific responder application is updated to a specific software version that includes a programming error that leads, in certain situations and in some landscapes, to a certain end-of-purpose check configuration value being incorrectly read within that responder application resulting therefore in failure of DPI tickets when that responder application responds to work packages. The AI/ML engine 706 can determine that a certain landscape includes that responder application that is updated to that software version and other similarities to other landscapes that have had reported issues. The AI/ML engine 706 can determine that a similar issue may be likely to occur in the certain landscape at some point in the future and that a test may be warranted, which may preemptively identify the issue and provide an opportunity for issue correction.

In some implementations the analyzer 707 may execute an apriori algorithm approach to compare relevant aspects of the landscape under consideration with the same aspects of other customers. Relevant parameters (e.g., “items”) for the apriori algorithm may include requester application type, responder application type, master data object type, configuration parameters, statistical information about work package feedback (e.g., can be blocked, cannot be blocked, timeout, etc.). Using the apriori algorithm, the analyzer 707 can check whether specific parameter combinations are associated with failing DPI tickets or issues in specific phases (e.g., whether a specific configuration is typically associated with a responder application running into a timeout).

At 714, after determining to perform a check, the DPI service 704 creates a test work package that includes a set of objects for which the DPI service 706 has determined an expected result. For example, the test work package includes Obj1, Obj2, and Obj3 objects for which expected results are can block, cannot block, and unknown object, respectively. The DPI service 704 can identify the test objects and the expected results from recent data in a past ticket data repository 716, or from other sources, as described above for the process 600.

At 716 and 718, the DPI service 704 sends the test work package including Obj1, Obj2, and Obj3 objects to a first application 720 and a second application 722, respectively. At 724 and 726, the first application 720 and the second application 722 process the work package, respectively, including determining a check status for each of the Obj1, Obj2, and Obj3 objects. At 728 and 730, the first application 720 and the second application 722 send a check work package response to the DPI service 704, respectively. The check work package response sent by the first application 720 includes expected results for the Obj1, Obj2, and Obj3 objects. However, the check work package response sent by the second application 722 includes an unexpected cannot-block vote 732 for the Obj1 object. A misconfiguration regarding the second application 722 may have caused the incorrect response. For example, the misconfiguration may be within the second application 722, may occur based on how the second application 722 interacts with the DPI service 704, an MDI service or some other service, or how based on how another application interacts with the second application 722.

At 734, the analyzer 707 evaluates the check work package responses from all responders and determines an overall result 736 of “unexpected result” (e.g., based at least on the unexpected cannot-block vote 732). At 738, the DPI service 704 sends an alert to an administrator 740 with an indication of the overall result 736. The alert can also include any information identified by the AI/ML engine 706 that caused the determination to trigger the check (e.g., information about changes common to this landscape and other landscapes that later encountered issues). The administrator can use information in the alert to initiate potential reconfiguration of the landscape. The administrator may also submit a request to the DPI service 704 to trigger a subsequent additional check after any reconfigurations have occurred. At 742, the DPI service 704 records the overall result 736, check work package response information, and current configuration data and other state information in a results store 744 of the DPI service 704. Similar information may also or alternatively be stored in the log 710.

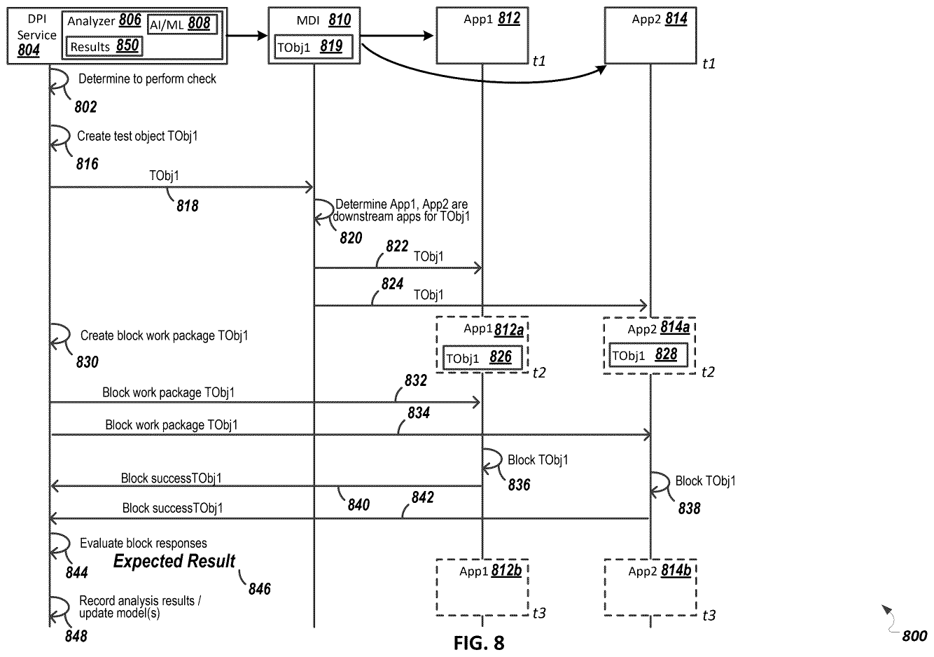

FIG. 8 is a swim lane diagram of an example process 800 for testing a multiple-application landscape by a data privacy integration service. At 802, a DPI service 804 determines to perform a check of a landscape. The DPI service 804 can determine to perform the check in similar ways as those described above for the process 700, such as an analyzer 806, or more particularly, an AI/ML engine 808, determining that the landscape may have similar characteristics as other landscapes for which problems have occurred. As another example, the DPI service 804 can determine to perform the check on a periodic basis (e.g., monthly). As yet another example, the DPI service 804 can determine to perform the check in response to an event (e.g., a configuration change of the DPI service 804, an MDI service 810, or a responder application such as a first application 812 or a second application 814).

At 816, the DPI service 804 creates or identifies a test object TObj1. In some implementations, the test object can include a flag that communicates to applications that transactional data is not to be created for the test object. At 818, the DPI service 804 sends the test object to the MDI service 810 (e.g., as illustrated by a test object copy 819 in the MDI service 810). The DPI service can be configured as an upstream application to the MDI service 810, in an MDI architecture, for example. The first application 812 and the second application 814 can be downstream applications to the MDI service 810. At 820, the MDI service 810 can determine that the first application 812 and the second application 814 are downstream applications.

At 822 and 824, the MDI service 810 distributes the test object to the first application 812 and the second application 814, respectively. Accordingly, the first application 812 and the second application 814 have a respective test object copy 826 or 828, respectively, at a time point t2 (e.g., in contrast to a timepoint t1 at which neither application has the test object, as illustrated by states 812a and 814a of the first application 812 and the second application 814, respectively).

At 830, the DPI service 804 creates a block work package for the test object. At 832 and 834, the DPI service 804 sends the block work page for the test object to the first application 812 and the second application 814, respectively. At 836 and 838, the first application 812 and the second application 814 block the test object in response to processing the block work package, respectively. At 840 and 842, the first application 812 and the second application 814 send a block success indication to the DPI service 804, respectively.

At 844, the analyzer 806 analyzes the responses to the block work package and determines an overall result 846 of expected-result, since each application that received the block work package reported an expected block success after successfully blocking the test object. At 848, the DPI service 804 records the overall result 846 and any supplemental information (e.g., service or responder configuration information, current landscape, service, or responder state, information leading to the check triggering, etc.) in a results store 850. The AI/ML engine 808 or more generally the analyzer 806 can be updated based on the results of the check.

The first application 812 and the second application 814 can delete the test object, thus resulting in a state 812b or 814b, respectively, shown for time point t3 at which neither application has the test object. The test object may be deleted immediately in response to or as part of blocking if no retention periods apply to the test object (or may be deleted after any retention periods, such as a default retention period, expire for the test object in a given application).

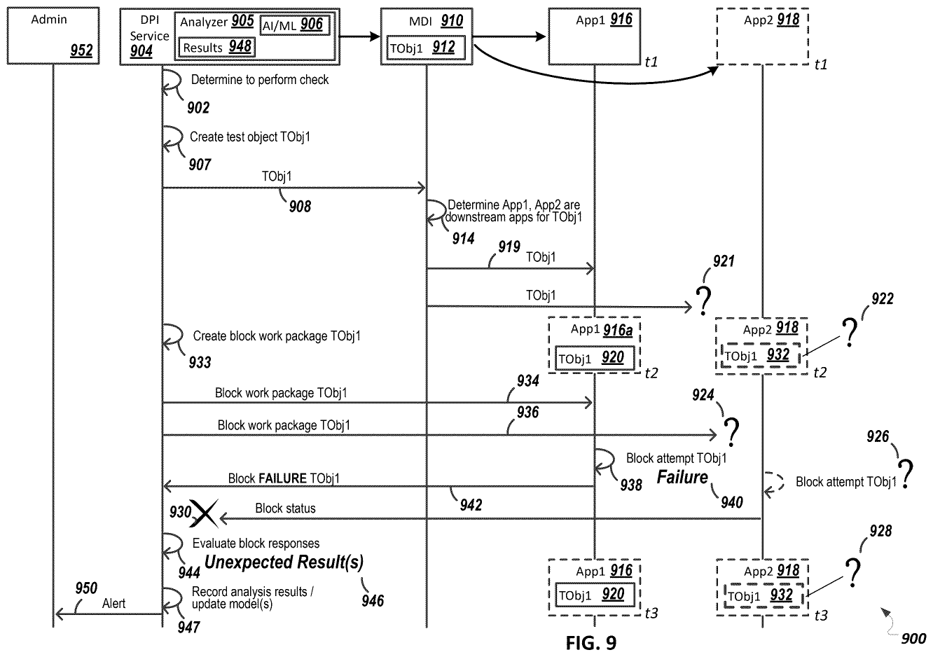

FIG. 9 is a swim lane diagram of an example process 900 for testing a multiple-application landscape by a data privacy integration service. At 902, a DPI service 904 determines to perform a check of a landscape. The DPI service 904 can determine to perform the check in similar ways as those described above for the process 800, such as by using an analyzer 905 or an AI/ML engine 906.

At 907, the DPI service 904 creates or identifies a test object TObj1 (e.g., in a manner similar to that described above for the process 800). At 908, the DPI service 904 sends the test object to an MDI service 910 (e.g., as illustrated by a test object copy 912 in the MDI service 910). At 914, the MDI service 910 determines that a first application 916 and a second application 918 are each downstream applications to the MDI service 910. At 919, the MDI service 910 sends the test object to the first application 916 (e.g., as illustrated by a test object copy 920 included in the first application 916 at a time point t2 (e.g., as illustrated by respective application state 916a that differs from a state at time point t1 at which the first application 916 does not have the test object)).

The remainder of the discussion of FIG. 9 mostly focuses on descriptions of possible failures that can occur with respect to the test object and the second application 918, as illustrated in the swim lane diagram at various points using question-mark symbols 921, 922, 924, 926, 928 and a symbol 930. For example, the symbol 921 represents different possible failure scenarios regarding the potential sending or non-sending of the test object to the second application 918 by the MDI service 910. For example, the MDI service 910 may fail to send the test object (e.g., due to a misconfiguration in the MDI service 910 regarding the downstream status of the second application 918, at least with regards to the object type of the test object). As another example, the MDI service 910 may send the test object but the test object may fail to reach the second application 918 due to communication issues in the landscape. As yet another example, the second application 918 may be misconfigured so that the second application 918 does not properly receive or retrieve the test object even though the MDI service 910 and the communications infrastructure is operating properly. Accordingly, as illustrated by the symbol 922, the second application 918 may or may not have a test object copy 932 at the second application 918 at the time point t2.

At 933, the DPI service 904 continues processing of the check by creating a block work package for the test object. At 934, the DPI service 904 sends the block work package to the first application 916. At 936, the DPI service 904 attempts to send the block work package to the second application 918. As illustrated by the symbol 924, the second application 918 may or may not receive the block work package (e.g., due to a misconfiguration of the second application 918 or some other issue with the landscape or the DPI service 904 itself). Accordingly, the second application 918 may or may not attempt a block operation (e.g., as illustrated by the symbol 926), depending on whether the second application 918 receives the block work package.

At 938, the first application 916 attempts to block the test object. However, a misconfiguration in the first application 916 results in an unexpected block failure status 940. As an example, the first application 916 may somehow have and identify some remnant transactional data for the test object that is incorrectly stored in the first application 916 from some earlier processing which wasn't correctly removed. Accordingly, at 942, the first application 916 sends a block failure status regarding the test object to the DPI service 904. As mentioned, the second application 918 may not have received the block work package, and therefore may not send a block status to the DPI service 904 (e.g., as illustrated by the symbol 930). As another example, the second application 918 may have received the test work package and the block work package and sent (or attempted to send) a response to the DPI service 904, but a misconfiguration or error in the application, the landscape, or the DPI service 904 may have prevented the DPI service 904 from receiving a block response from the second application 918.

At 944, the analyzer 905 evaluates block responses received by the DPI service 904. The analyzer 905 can determine that the block failure status sent by the first application 916 is an unexpected result. Additionally, the analyzer 905 can determine that no block status has been received from the second application 918 (which can occur for a variety of reasons, as described above). Accordingly, the analyzer 905 can determine an analysis result 946 of unexpected-results.

At 947, the DPI service 904 can record the analysis result 946 and any supporting details or information in a results store 948. The DPI service 904 can update the AI/ML engine 906 based on the check results. At 950, the DPI service 904 can send an alert to an administrator 952. The alert can include the analysis result 946 and any supporting information, to enable the administrator 952 to troubleshoot issues with affected responders or the landscape itself and to also perform any cleanup resulting from the fact that the check did not proceed as expected. For instance, as illustrated at a time point t3, the first application 916 still has the test object copy 920 and the second application 918 may or may not have the test object copy 932. Accordingly, the administrator 952 can initiate a deletion of any test object remnants in any affected responder applications.

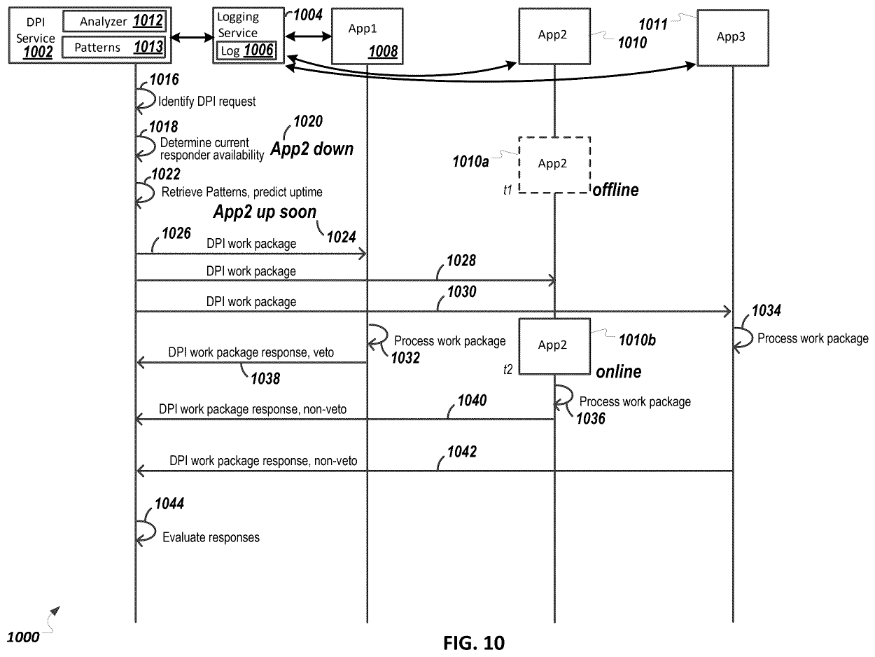

FIG. 10 is a swim lane diagram of an example process 1000 for improving availability of a data privacy integration service 1002. The DPI service 1002, in conjunction with a logging service 1004 (which may be part of or separate from the DPI service 1002), records, in a log 1006, DPI activity regarding responder applications that include a first application 1008, a second application 1010, and a third application 1011. An analyzer 1012, which, in some implementations, can include AI/ML models, can analyze the log 1006 to determine patterns 1013 of responder uptime and downtime, based on information in the log 1006 that indicates responder activity records, responder response time, responder failures to respond, etc.

At 1016, the DPI service 1002 identifies a DPI request (e.g., from a requester (not shown)). At 1018, the DPI service 1002 determines current responder availability (e.g., for the first application 1008, the second application 1010, and the third application 1011). For example, the DPI service 1002 can determine an availability result 1020 of the second application 1010 being down (e.g., offline) at a time point t1 (e.g., as illustrated by a state 1010a of the second application 1010).

At 1022, the DPI service 1002 retrieves the patterns 1013 and determines whether the second application 1010 may be available in time for handling of a work package. For example, the DPI service 1002 can determine a predicted uptime result 1024 of the second application 1010 coming back online “soon” (e.g., within an appropriate time window for retrieving and processing a work package before a work package would time out). Accordingly, the DPI service 1002 can determine to proceed with handling the DPI request and to include the second application 1010 as a work package recipient.

At 1026, 1028, and 1030, the DPI service 1002 sends a DPI work package to the first application 1008, the second application 1010, and the third application 1011, respectively. At 1032 and 1034, the first application 1008 and the third application 1011 process the received work package, respectively.

At a time point t2, at some point after creation of the work package and before the work package expires, the second application 1010 comes back online (e.g., as predicted), as illustrated by a state 1010b of the second application 1010. At 1036, the second application 1010 processes the work package (e.g., after retrieving the work package from a queue in which the work package was placed when the second application 1010 was offline).

At 1038, 1040, and 1042, the first application 1008, the second application 1010, and the third application 1011 each send a work package response to the DPI service 1002, respectively (e.g., in various possible time orders). At 1044, the DPI service 1002 evaluates the work package responses received from the first application 1008, the second application 1010, and the third application 1011. Because each application has provided a response, the DPI service 1002 is enabled to successfully continue with the protocol (e.g., by determining an overall result, determining a next action (e.g., block command, disassociate purpose command, etc.). By successfully predicting an imminent uptime of the second application 1010, the DPI service 1002 has avoided rejecting the DPI request based on the unavailability of the second application 1010 at the time of the request.

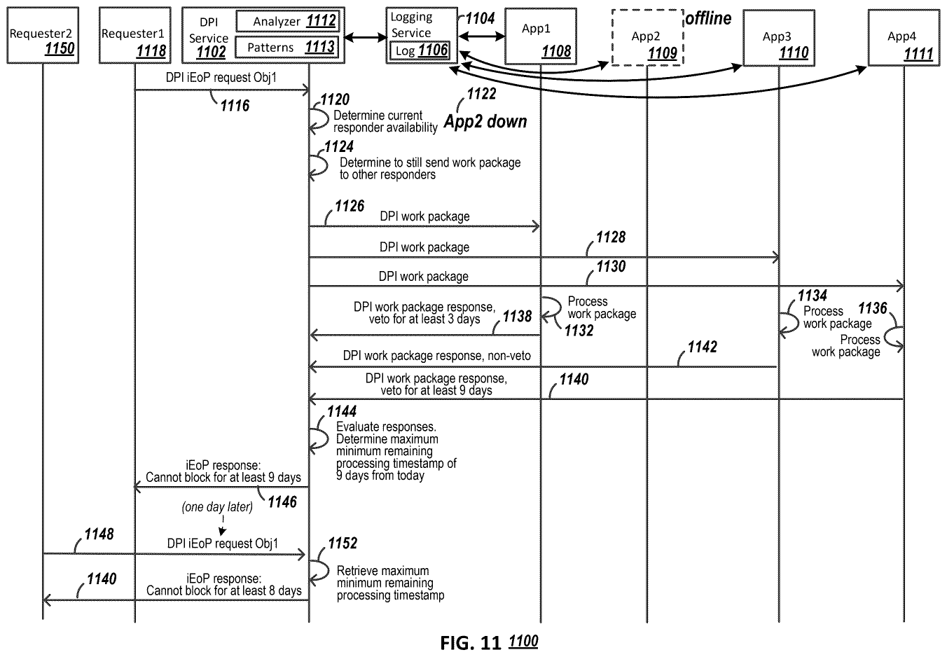

FIG. 11 is a swim lane diagram of an example process 1100 for improving availability of a data privacy integration service 1102. Similar to the process 1000, the DPI service 1102, in conjunction with a logging service 1104, records, in a log 1106, DPI activity regarding responder applications that include a first application 1108, a second application 1109, a third application 1110, and a fourth application 1111. An analyzer 1112, which, in some implementations, can include AI/ML models, can analyze the log 1106 to determine patterns 1113 of responder uptime and downtime, based on information in the log 1106 that indicates responder activity records, responder response time, responder failures to respond, etc.

At 1116, the DPI service 1102 receives a DPI request from a first requester 1118. At 1120, the DPI service 1102 determines current responder availability. For example, the DPI service 1102 can determine an availability result 1122 of the second application 1109 being down (e.g., offline). The DPI service 1102 can also determine that the second application 1109 is predicted to remain down for some time (or, as another example, the DPI service 1102 might not be able to make a confident prediction about subsequent availability of the second application 1109).

In some examples, the DPI service 1102 can also send a work package to the second application 1109, even when anticipating that the second application 1109 might not respond to the work package. The DPI service 1102 can gather responses from other applications (and although maybe unlikely, the DPI service 1102 may still be able to receive responses from the second application 1109, if the second application 1109 comes back online sooner than expected). The DPI service 1109 may be able to determine useful maximum minimum remaining processing time timestamp information from other applications (e.g., collective responses from other applications may result in a conclusion from those application responses that a veto situation exists for a first set of objects, likely for at least the next X days). For a second group of objects, the DPI service 1109 may be able to determine that no other application has raised a veto but that a response from the second application 1109 is still needed. If another DPI request is received for an object in the first set of objects before the X number of days has occurred, the DPI service 1102 can respond to the request with an indication that the object cannot be blocked until at least the X number of days has occurred. If another DPI request is received for an object in the second set of objects, the DPI service 1102 can respond to the request with an indication that the object cannot be blocked and for an indefinite amount of time (e.g., due to no vote yet received from the second application).

Referring again to the illustrated example, at 1124 the DPI service 1102 makes a determination to still send work packages to other responders, despite the second application 1109 being down (and where likely second application 1109 uptime is not relatively imminent or is unknown). For example, the DPI service 1102 can determine that a value of obtaining minimum remaining processing time information for an object of the DPI request from applications is greater than a processing resource of obtaining the minimum remaining processing time information for the object. Minimum remaining processing time information for the object for an application can indicate, for example, an earliest predicted time at which the application predicts it would be able to block the object or to disassociate a purpose form the object (e.g., depending on the type of DPI protocol associated with the request). Obtaining such information may be useful for the first requester 1118 and can also be useful for other subsequent requesters, as described below.

At 1126, 1128, and 1130, the DPI service 1102 sends a DPI work package to the first application 1108, the third application 1110, and the fourth application 1111, respectively (e.g., while avoiding sending the work package to the second application 1109 since the DPI service 1102 knows that the second application 1109 is unavailable). At 1132, 1134, and 1136, the first application 1108, the third application 1110, and the fourth application 1111 process the received work package, respectively.

At 1138, the first application 1108 sends a work package response to the DPI service 1102 that includes a veto vote along with an accompanying minimum remaining processing time timestamp that corresponds to 3 days from a current day/time. Similarly, at 1140, the fourth application 1111 sends a work package response to the DPI service 1102 that includes a veto vote along with an accompanying minimum remaining processing time timestamp corresponding to 9 days from the current day/time. At 1142, the third application 1110 sends a work package response to the DPI service 1102 that includes a non-veto vote (e.g., can currently block object or disassociate a purpose from the object).

At 1144, the DPI service 1102 evaluates work package responses. The DPI service can focus on evaluating the veto votes and accompanying minimum remaining processing time values (e.g., the DPI service 1102 is already aware that a consensus non-veto vote cannot occur for the DPI request). The DPI service can determine, from among received minimum remaining processing time values, a maximum of those values (which can be referred to as a maximum minimum remaining processing time timestamp). The maximum minimum remaining processing time value represents an earliest time at which a consensus non-veto vote can occur for the object in the multiple-application landscape (e.g., since that is the earliest time at which a responder who uses the object the longest can provide a non-veto vote).

At 1146, the DPI service 1102 provides a response to the first requester 1118 with an indication of the maximum minimum remaining processing time timestamp corresponding to nine additional days from the current day. The example shown is an example message for the iEoP protocol that communicates to the first requester 1118 that the DPI service would likely not be able to trigger successful blocking of the object in the landscape for at least 9 days (e.g., based on the response from the fourth application 1111 indicating a state of current configuration and transactional data of the fourth application 1111). Therefore, the first requester 1118 can be informed that any DPI request for the object before that time period elapses will also result in object blocking not being triggered.

At 1148, one day later, a second requester 1150 sends a DPI request for the object to the DPI service 1102. At 1152, the DPI service 1102 can retrieve a previously determined maximum minimum remaining processing time timestamp, determine that the current time is before that timestamp, and send, at 1154, a response to the second requester 1150 that indicates that the DPI service 1102 cannot trigger blocking of the object for at least another 8 days.

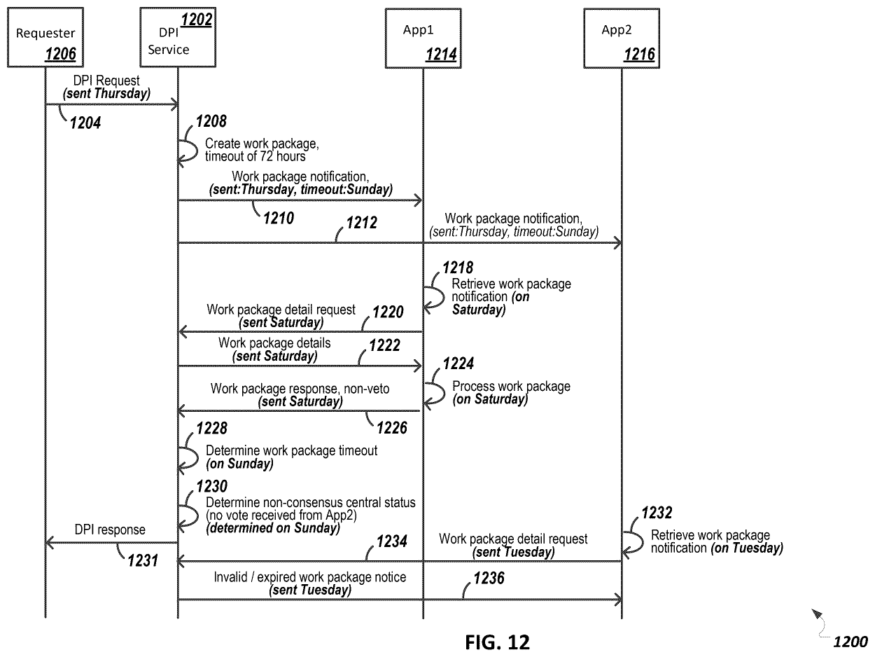

FIG. 12 is a swim lane diagram of an example process 1200 that illustrates problems related to responder application downtime. In some landscapes, some responder applications may have scheduled uptime or downtime with respect to interactions with a DPI service 1202. For example, some responder applications may only connect to the DPI service 1202 occasionally, to check for any needed work, pending work packages, notifications, etc. However, in such cases, DPI work package processing can be inefficient or even result in timeouts when different responders have different uptime schedules.

For example, at 1204, the DPI service 1202 can receive, on a particular Thursday, a DPI request from a requester 1206. At 1208, the DPI service 1202 can create a work package in response to the request and set a timeout value for the work package of seventy two hours (e.g., indicating responder applications will have up to seventy two hours to respond to the work package, meaning a timeout date is the following Sunday).

Accordingly, at 1210 and 1212, the DPI service 1202 sends, on Thursday, a work package notification about the work package with the timeout of Sunday to a first application 1214 and a second application 1216.

At 1218, on that Saturday, the first application 1214 retrieves the work package notification (e.g., from a local queue). At 1220, also on Saturday, the first application 1214 sends a request to the DPI service 1202 for work package details corresponding to the work package notification. At 1222, the DPI service 1202 sends, on Saturday, the requested work package details to the first application 1214. At 1224, on Saturday, the first application 1214 processes the work package and determines a work package result. At 1226, also on Saturday, the first application 1214 sends a work package response, with a work package result of a non-veto vote, to the DPI service 1202.

At 1228, on Sunday at the timeout time point for the work package, the DPI service 1202 determines that a work package timeout has occurred for the work package. The DPI service 1202 can perform different types of processing in response to a timeout, such as invalidating a work package, removing work package details, etc. Additionally, the DPI service 1202 can determine a result of the DPI request, based on the occurrence of the timeout.

At 1230, for example, the DPI service 1202 can determine a non-consensus central status for the DPI request (e.g., not all applications can block, not all applications can disassociate a purpose from an object) based at least on the DPI service 1202 not receiving a vote from the second application 1216. At 1231, the DPI service 1202 sends a response to the requester 1206 with an indication of the non-consensus status.

At 1232, on Tuesday after the occurrence of the work package timeout on Sunday, the second application 1216 retrieves the work package notification. At 1234, also on Tuesday, the second application 1216 sends a request to the DPI service 1202 for work package details corresponding to the work package notification. At 1236, on Tuesday, the DPI service 1202 sends a response to the request for work package details to the second application 1216. The response can indicate the work package is invalid or expired. Rather than deal with these types of expiration situations, the DPI service 1202 can send work packages to responders based on specific responder anticipated availability, as described below.

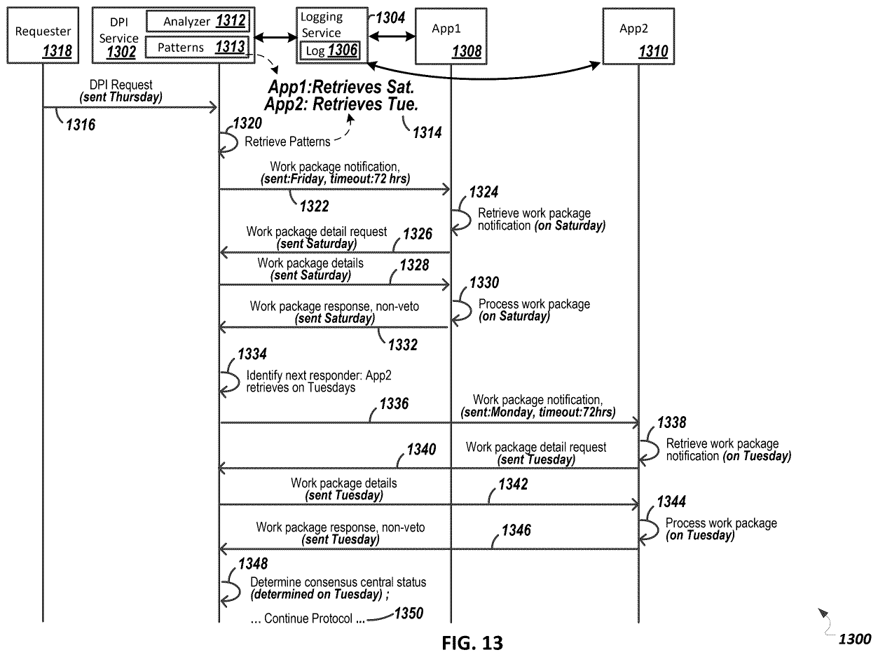

FIG. 13 is a swim lane diagram of an example process 1300 for scheduling data privacy integration work packages based on anticipated responder availability. A DPI service 1302, in conjunction with a logging service 1304 (which may be part of or separate from the DPI service 1302), records, in a log 1306, DPI activity regarding responder applications that include a first application 1308 and a second application 1310. An analyzer 1312, which, in some implementations, can include AI/ML models, can analyze the log 1306 to determine patterns 1313 of responder uptime and downtime, based on information in the log 1306 that indicates responder activity records, responder response time, responder failures to respond, etc.

The analyzer 1312 can determine certain days or other time windows during which the analyzer 1312 predicts that certain responders will likely respond to DPI requests. For instance, the analyzer 1312 has determined, among the patterns 1313, patterns 1314 for the first application 1308 and the second application 1310 that indicate that the first application 1308 and the second application 1310 have patterns of retrieving DPI information on Saturdays or Tuesdays, respectively, and may therefore be likely to respond, before a respective work package timeout, if the DPI service 1302 were to send work packages to those applications slightly before those predicted retrieval days (e.g., on the morning of those days or the day before).

For example, at 1316, a requester 1318 sends, on a Thursday, a request to the DPI service 1302. At 1320, the DPI service 1302 retrieves pattern information for the applications in the landscape, including the patterns 1314 for the first application 1308 and the second application 1310. The DPI service 1302 can determine days/times to send work package notifications to applications based on the retrieved patterns. For example, the DPI service 1302 can determine to send work package notifications to the first application 1308 and the second application 1310 on a Friday and a Monday, respectively (e.g., corresponding to one day before respective predicted retrieval dates).

The DPI service 1302 can identify, from the retrieved patterns, a first application (or set of applications) to first receive a work package notification. For example, the DPI service 1302 can identify the first application 1308 as a first work package notification recipient, based on the predicted availability day of Saturday being a next closest succeeding weekday after the receipt, on Thursday, of the DPI request from the requester 1318.

At 1322, on that Friday, the DPI service 1302 sends a work package notification to the first application 1308, with a configured timeout value of seventy two hours. At 1324, on that Saturday, the first application 1308 retrieves the work package notification. At 1326, on Saturday, the first application 1308 sends a work package detail request to the DPI service 1302. At 1328, also on Saturday, the DPI service 1302 sends work package details to the first application 1308 in response to the work package detail request.

At 1330, on Saturday, the first application 1308 processes the work package and determines a work package result. At 1332, on Saturday, the first application 1308 sends a work package response to the DPI service 1302 that includes a non-veto vote (e.g., can block object, can disassociate purpose from object).

At 1334, in response to the work package response from the first application 1308 corresponding to a non-veto vote, the DPI service 1302 identifies a next responder recipient of a work package notification, based on the patterns retrieved by the DPI service 1302 at step 1320. For example, the DPI service 1302 can identify next responder(s) that are predicted to be available at a next closest succeeding weekday after the predicted availability day of the first application 1308. For example, the DPI service 1302 can identify the second application 1310 as a next responder with a target notification send date of Monday (e.g., one day before the predicated availability day of Tuesday of the second application 1310).

At 1336, on Monday, the DPI service 1302 sends a work package notification to the second application 1310, with a configured timeout value of seventy two hours. At 1338, on Tuesday, the second application 1310 retrieves the work package notification. At 1340, on Tuesday, the second application 1310 sends a work package detail request to the DPI service 1302. At 1342, also on Tuesday, the DPI service 1302 sends work package details to the second application 1310 in response to the work package detail request. At 1344, on Tuesday, the second application 1310 processes the work package and determines a work package result. At 1346, the second application 1310 sends a work package response to the DPI service 1302 that includes a non-veto vote (e.g., can block object, can disassociate purpose from object).

At 1348, on Tuesday, the DPI service 1302 evaluates work package responses and determines a consensus central status based on all responders responding with a non-veto vote (e.g., indicating all applications can block an object or all applications can disassociate a purpose from an object). Accordingly, the DPI service 1302 can continue with DPI protocol handling of the request of the requester 1318, as indicated by a note 1350. For instance, the DPI service can continue protocol handling by creating a sending a block work package or by creating and sending a disassociate purpose from object work package.

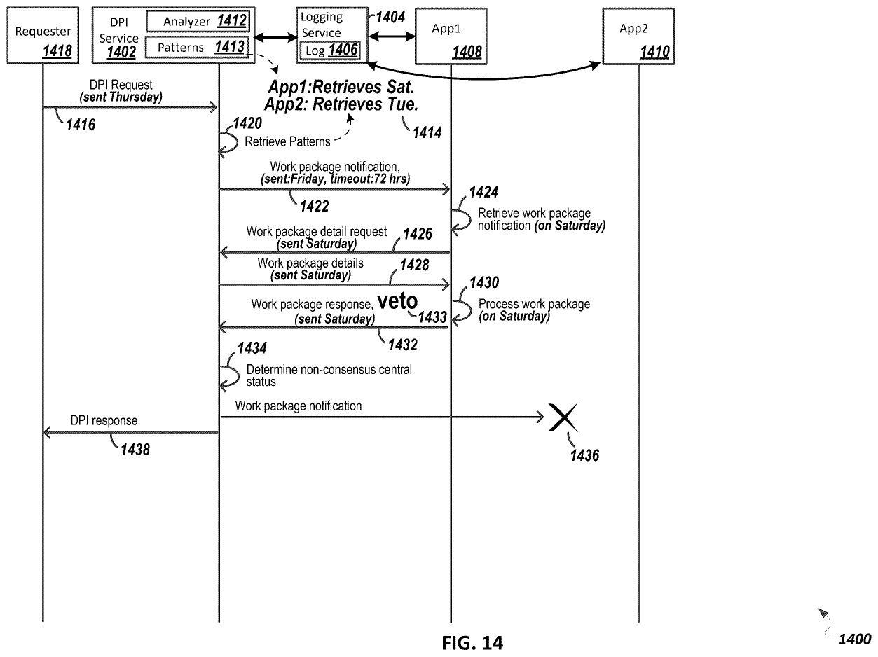

FIG. 14 is a swim lane diagram of an example process 1400 for scheduling data privacy integration work packages based on anticipated responder availability. As described above, a DPI service 1402, in conjunction with a logging service 1404 can generate a log 1406 of DPI activity regarding responder applications that include a first application 1408 and a second application 1410. An analyzer 1412 can analyze the log 1406 to determine patterns 1413 of responder uptime and downtime, based on information in the log 1406 that indicates responder activity records, responder response time, responder failures to respond, etc. The patterns 1413 can include patterns 1414 for the first application 1408 and the second application 1410.

At 1416, a requester 1418 sends, on a Thursday, a request to the DPI service 1402. At 1420, the DPI service 1402 retrieves pattern information for the applications in the landscape, including the patterns 1414 for the first application 1408 and the second application 1410. The DPI service 1402 can determine to send work package notifications to the first application 1408 and the second application 1410 on a Friday and a Monday, respectively. The DPI service 1402 can identify the first application 1408 as a first work package notification recipient.

Accordingly, at 1422, on that Friday, the DPI service 1402 sends a work package notification to the first application 1408, with a configured timeout value of seventy two hours. At 1424, on that Saturday, the first application 1408 retrieves the work package notification. At 1426, on Saturday, the first application 1408 sends a work package detail request to the DPI service 1402. At 1428, also on Saturday, the DPI service 1402 sends work package details to the first application 1408 in response to the work package detail request.

At 1430, on Saturday, the first application 1408 processes the work package and determines a work package result. At 1432, on Saturday, the first application 1408 sends a work package response to the DPI service 1402 that includes a veto vote 1433 (e.g., can block object, can disassociate purpose from object).

At 1434, in response to the work package response from the first application 1408 corresponding to a veto vote, the DPI service 1402 determines that a non-consensus central status has been reached with respect to the request from the requester 1418. Accordingly, the DPI service does NOT send a work package notification to the second application 1410 (e.g., as illustrated by a symbol 1436). At 1438, the DPI service sends a DPI response to the requester 1418 that indicates the non-consensus central status.

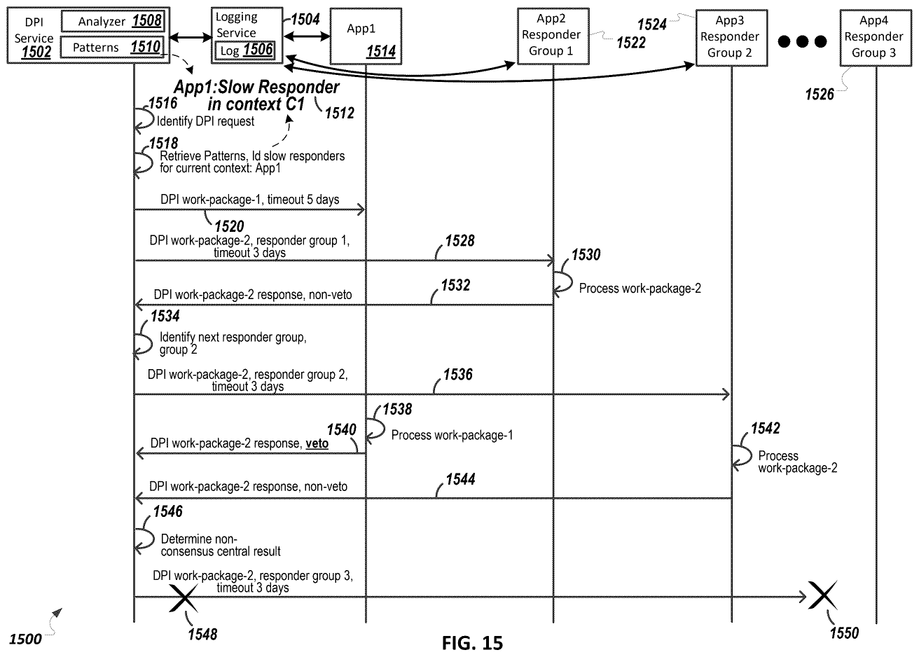

FIG. 15 is a swim lane diagram of an example process 1500 for scheduling data privacy integration work packages based on anticipated responder response time. As described above, a DPI service 1502, in conjunction with a logging service 1504 can generate a log 1506 of DPI activity regarding responder applications. An analyzer 1508 (which can include AI/ML portions) can analyze the log 1506 to determine patterns 1510 of responders with respect to response time, based on information in the log 1506 that indicates responder activity records, responder response time, responder failures to respond, etc. The patterns 1510 can include a pattern 1512 for a first application 1514 that indicates that the first application 1514 is likely to be a slow responder (e.g. likely to respond only after at least a threshold time has passed) in a certain context C1.

The context C1 can be based on one or more factors, such as temporal context (e.g., day of week, time of day, time of year, etc.). As another example, the context C1 can be based on object type(s) of object(s) in work packages, size of work package, etc. As another example, the context C1 can be based on type of DPI request (e.g., iEoP or APD).

At 1516, the DPI service 1502 identifies a DPI request (e.g., from a requester (not shown)). At 1518, the DPI service 1502 retrieves the patterns 1510 and determines whether any landscape applications are considered as slow responders for a current context associated with the DPI request. For instance, the DPI service 1502 can identify the first application 1514 as a slow responder in the current context.

Accordingly, at 1520, the DPI service sends a DPI work package (e.g., DPI work-package-1) to the first application 1514, where the work package has a timeout value (e.g., five days) that is greater than a default work package timeout value (which may be, for example, three days). The first application 1514, being a slow responder, may not start (or may not complete) processing of the work package for some number of days.

The DPI service 1502 can group slow responders into a group, if more than one responder is identified as a slow responder, and then send the work package to each responder in the “slow responder” group. The DPI service 1502 can also group other “non-slow” responders into regular responder group configurations, as described herein with respect to the responder group configurations 144 of FIG. 1. For instance, a second application 1522 can be included in a first responder group, a third application 1524 can be include in a second responder group, and a fourth application 1526 can be included in a third responder group. Although responder groups are shown, for convenience, as including one application, in practice, responder groups may and often do include multiple applications. The DPI service 1502 can handle slow responders as a separate group (e.g., as a first thread of evaluation) and can handle other, traditional responder groups, in sequence, according to traditional responder group processing (e.g., as a second thread of evaluation).

At 1528, the DPI service 1502 sends a DPI work package (e.g., DPI work-package-2) to the second application 1522, where the work package has a timeout value (e.g., three days) that is equal to the default work package timeout value. The work-package-2 work package is sent before a response has been received from the first application 1514 for the work-package-1 work package. At 1530, the second application 1522 processes the work-package-2 work package. The second application 1522 can process its work package before the first application 1514 has finished (or even started) processing of its work package, for example. At 1532, the second application 1522 sends a work package response for the work-package-2 work package, with an indication of a non-veto vote, to the DPI service 1502.

At 1534, the DPI service 1502 identifies a next responder group (e.g., the second responder group that includes the third application 1524). At 1536, the DPI service 1502 sends a DPI work-package-2 work package to the third application 1524, where the work package has a timeout value (e.g., three days) that is equal to the default work package timeout value.

At 1538, the first application 1514 processes the work-package-1 work package (e.g., before the third application 1524 has completed processing of its work package). At 1540, the first application 1514 sends a work package response for the work-package-1 work package, with an indication of a veto vote, to the DPI service 1502.

At 1542, the third application 1524 processes the work-package-2 work package. At 1544, the third application 1524 sends a work package response for the work-package-2 work package, with an indication of a non-veto vote, to the DPI service 1502.

At 1546, the DPI service 1502 determines a non-consensus central result for the DPI request, based at least on the veto vote received from the first application 1514. Based on the non-consensus central status, the DPI service does NOT send a work package to the fourth application 1526 or any other responders in the third or later responder groups, as illustrated by symbols 1548 and 1550.

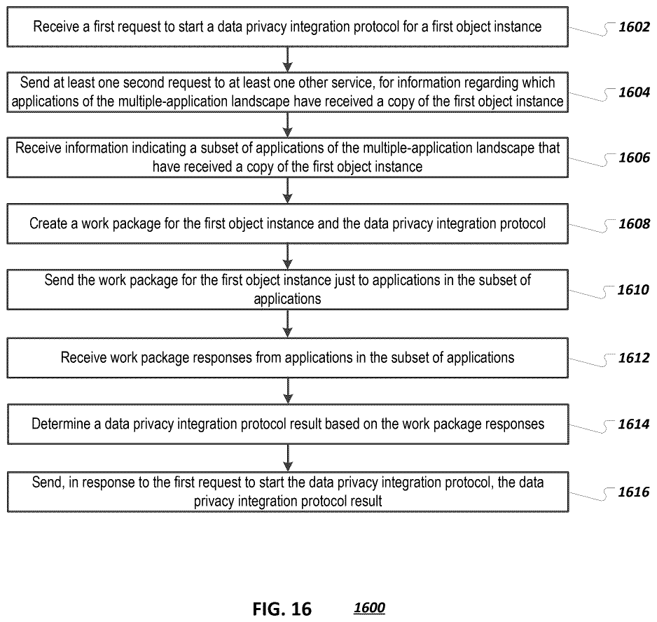

FIG. 16 is a flowchart of an example method 1600 for reducing participants in data privacy integration protocols. It will be understood that method 1600 and related methods may be performed, for example, by any suitable system, environment, software, and hardware, or a combination of systems, environments, software, and hardware, as appropriate. For example, one or more of a client, a server, or other computing device can be used to execute method 1600 and related methods and obtain any data from the memory of a client, the server, or the other computing device. In some implementations, the method 1600 and related methods are executed by one or more components of the system 100 described above with respect to FIG. 1. For example, the method 1600 and related methods can be executed by the data privacy integration service 117 of FIG. 1.

At 1602, a first request to start a data privacy integration protocol for a first object instance is received, at a data privacy integration service that manages data privacy integration for a multiple-application landscape. The data privacy integration protocol can be an integrated end of purpose protocol in which a respective responding application provides a vote for an object indicating whether the respective responding application can block the object. The data privacy integration protocol can be an aligned purpose disassociation protocol in which a respective responding application provides a vote for an object indicating whether the respective responding application can disassociate a purpose from the object. The first object instance can be a master data object instance representing a first data subject.

At 1604, the data privacy integration service sends at least one second request to at least one other service for information regarding which applications of the multiple-application landscape have received a copy of the first object instance. The at least one other service can include a master data integration service that distributes master data objects to applications in the multiple-application landscape. The master data integration service can maintain master data distribution records which indicate master data object instances have been distributed to which downstream applications in the multiple-application landscape. The master data integration service can determine, based on the master data distribution records and in response to the second request from the data privacy integration service, the information regarding which applications of the multiple-application landscape have received a copy of the first object instance.

The at least one other service can include a proxy service that integrates with applications that do not integrate with the master data integration service. The proxy service can be configured to determine which applications, of the applications that do not integrate with the master data integration service, have received a copy of the first object instance.

In some cases, the data privacy integration service sends the second request to the master data integration service but not the proxy service, based on the multiple-application landscape only having applications that integrate with the master data integration service. In some cases, the data privacy integration service sends the second request to both the master data integration service and the proxy service, based on the multiple-application landscape having both applications that integrate with the master data integration service and at least one application that does not integrate with the master data integration service.

The at least one other service can include a semantic service that determines, in response to the second request, which applications have received the copy of the first object instance based on semantics of an object identifier of the first object instance.

At 1606, the data privacy integration service receives, from the at least one other service, the information indicating a subset of applications of the multiple-application landscape that have received a copy of the first object instance.

At 1608, a work package is created for the first object instance and the data privacy integration protocol.

At 1610, the work package for the first object instance is sent to applications in the subset of applications without sending the work package to landscape applications not in the subset of applications.

At 1612, work package responses are received from applications in the subset of applications.

At 1614, a data privacy integration protocol result is determined based on the work package responses.

At 1616, the data privacy integration protocol result is sent in response to the first request to start the data privacy integration protocol.

The data privacy integration service can receive a second data privacy integration request for the data privacy integration protocol and can determine to send a data privacy integration work package for the second data privacy integration request to all applications in the multiple-application landscape and to not send the second request to the at least one other service, such as based on a performance analysis of both approaches.

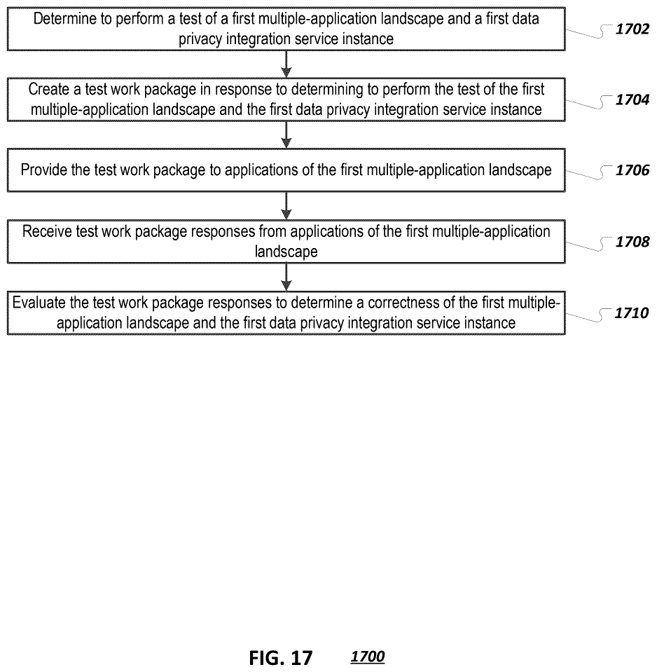

FIG. 17 is a flowchart of an example method 1700 for testing data privacy integration protocols. It will be understood that method 1700 and related methods may be performed, for example, by any suitable system, environment, software, and hardware, or a combination of systems, environments, software, and hardware, as appropriate. For example, one or more of a client, a server, or other computing device can be used to execute method 1700 and related methods and obtain any data from the memory of a client, the server, or the other computing device. In some implementations, the method 1700 and related methods are executed by one or more components of the system 100 described above with respect to FIG. 1. For example, the method 1700 and related methods can be executed by the data privacy integration service 117 of FIG. 1.

At 1702, a determination is made to perform a test of a first multiple-application landscape and a first data privacy integration service instance that manages data privacy integration of multiple applications in the first multiple-application landscape. Determining to perform the test can include identifying a next period of periodic testing of the first multiple-application landscape and the first data privacy integration service instance. Determining to perform the test can include receiving a request to perform the test. Determining to perform the test can include determining to perform the test in response to identifying at least one configuration change in the first data privacy integration service instance, an application of the first multiple-application landscape, or middleware used by the first data privacy integration service instance.

Determining to perform the test can include determining to perform the test in response to determining that a similarity between a first combination of the first data privacy integration service instance and the first multiple-application landscape and a second combination of a second data privacy integration service instance and a second multiple-application landscape is greater than a threshold similarity. The similarity between the first combination of the first data privacy integration service instance and the first multiple-application landscape and the second combination of the second data privacy integration service instance and the second multiple-application landscape can be determined by a machine learning model. The machine learning model can analyze first logged activity data for the first data privacy integration service instance and second logged activity data for the second data privacy integration service instance. Logged activity data can include data privacy integration request handling information, responder application response information, and responder application response time and response failure information. The machine learning model can analyze 1) first configuration data for the first data privacy integration service instance and the first multiple-application landscape; and 2) second configuration data for the second data privacy integration service instance and the second multiple-application landscape. Configuration data can include data privacy integration service version information, responder application version information, and middleware version information.

At 1704, a test work package is created in response to determining to perform the test of the first multiple-application landscape and the first data privacy integration service instance. The test work package can be a check work package that instructs a responder application to perform a check for 1) a first object for which an expected response is an affirmative vote for a data privacy integration protocol; 2) a second object for which an expected response is a non-affirmative vote for the data privacy integration protocol; and 3) a third object for which an expected response is unrecognized object. The data privacy integration protocol can be an integrated end of purpose protocol in which a respective responding application provides the affirmative vote for an object when the respective responding application can block the object or the non-affirmative vote for the object when the respective responding application cannot block the object. The data privacy integration protocol can be an aligned purpose disassociation protocol in which a respective responding application provides the affirmative vote for an object when the respective responding application can disassociate a purpose from the object and the non-affirmative vote for the object when the respective responding application cannot disassociate the purpose from the object.

The test work package can be a block work package that instructs a responder application to block a fourth object that was provided to the responder application by the first data privacy integration service instance indirectly through a master data integration service.

At 1706, the test work package is provided to applications of the first multiple-application landscape.

At 1708, test work package responses are received from applications of the first multiple-application landscape.

At 1710, the test work package responses are evaluated to determine a correctness of the first multiple-application landscape and the first data privacy integration service instance. The correctness of the first multiple-application landscape and the first data privacy integration service instance can be determined to be correct based on determining that each responder application responded as 1) being able to block the first object; 2) being unable to block the second object; and 3) not recognizing the third object. The correctness of the first multiple-application landscape and the first data privacy integration service instance can be determined to be incorrect based on determining that at least one responder application responded as 1) being unable to block the first object; 2) able to block the second object; 3) recognizing the third object; or 4) not recognizing the first object or the second object.

The correctness of the first multiple-application landscape and the first data privacy integration service instance can be determined to be correct based on determining that each responder application responded as having successfully blocked the fourth object. The correctness of the first multiple-application landscape and the first data privacy integration service instance can be determined to be incorrect based on determining that at least responder application responded as having unsuccessfully attempted to block the fourth object. Or more generally, the correctness of the first multiple-application landscape and the first data privacy integration service instance can be determined to be incorrect based on determining that at least one responder application has not reported successful blocking of the fourth object. For example, a given responder application might not provide a response at all, due to an issue with the responder application or the landscape in general.

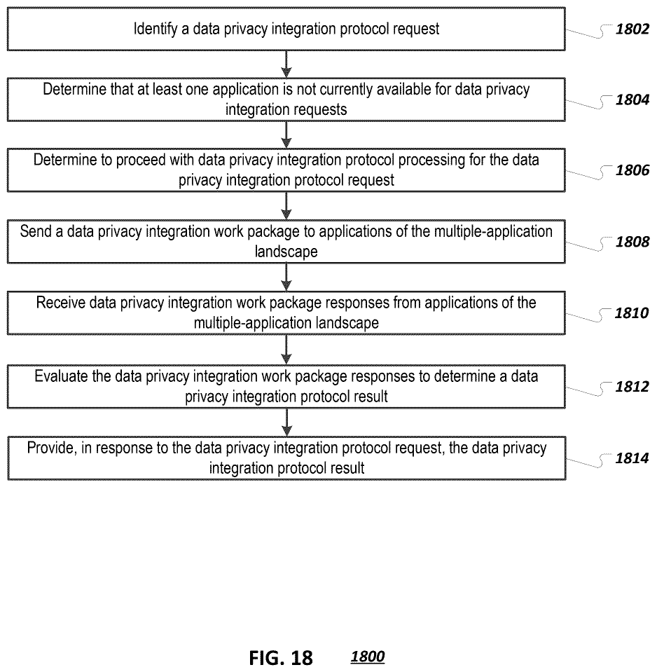

FIG. 18 is a flowchart of an example method 1800 for improving data privacy integration protocols based on application availability. It will be understood that method 1800 and related methods may be performed, for example, by any suitable system, environment, software, and hardware, or a combination of systems, environments, software, and hardware, as appropriate. For example, one or more of a client, a server, or other computing device can be used to execute method 1800 and related methods and obtain any data from the memory of a client, the server, or the other computing device. In some implementations, the method 1800 and related methods are executed by one or more components of the system 100 described above with respect to FIG. 1. For example, the method 1800 and related methods can be executed by the data privacy integration service 117 of FIG. 1.

At 1802, a data privacy integration protocol request is identified at a data privacy integration service that manages data privacy integration for a multiple-application landscape, a data privacy integration protocol request.

At 1804, application availability is determined of applications in the multiple-application landscape, including determining that at least one application is not currently available for data privacy integration requests.

At 1806, a determination is made to proceed with data privacy integration protocol processing for the data privacy integration protocol request. Determining to proceed with the data privacy integration protocol can include determining that at least one unavailable application that is currently unavailable is predicted to become available before a timeout of the data privacy integration work package occurs. A machine learning model can generate a prediction that the at least one unavailable application is likely to become available before the timeout of the data privacy integration work package occurs. The machine learning model can generate the prediction based on one or more of a context of the data privacy integration protocol request, scheduled application maintenance, logged application uptime, logged application downtime, logged application response time, and logged application response failures. The context of the data privacy integration protocol request can include at least one of a day and time of the data privacy integration protocol request, a location of a requester of the data privacy integration protocol request, or a type of the data privacy integration protocol request.

Determining to proceed with the data privacy integration protocol can include determining that a value of obtaining minimum remaining processing time information for an object of the data privacy integration protocol request from applications is greater than a processing resource of obtaining the minimum remaining processing time information for the object. The data privacy integration protocol request can be an integrated end of purpose protocol request in which a respective responding application provides a vote for an object indicating whether the respective responding application can block the object and if the respective responding application cannot block the object the respective responding application also provides minimum remaining processing time information for the object that indicates an earliest predicted time at which the respective responding application predicts it would be able to block the object. The data privacy integration protocol request can be an aligned purpose disassociation protocol request in which a respective responding application provides a vote for an object indicating whether the respective responding application can disassociate a purpose from the object and if the respective responding application cannot disassociate the purpose from the object the respective responding application also provides minimum remaining processing time information for the object that indicates an earliest predicted time at which the respective responding application predicts it would be able to disassociate the purpose form the object.

At 1808, a data privacy integration work package is sent to applications of the multiple-application landscape. The data privacy integration work package can be sent to the at least one unavailable application. The at least one unavailable application can become available, retrieves the data privacy integration work package, and process the data privacy integration work package before the timeout of the data privacy integration work package occurs.

At 1810, data privacy integration work package responses are received from applications of the multiple-application landscape. Data privacy integration work package responses received from applications can include at least one veto vote and corresponding minimum remaining processing time information.

At 1812, the data privacy integration work package responses are evaluated to determine a data privacy integration protocol result. Evaluating the data privacy integration work package responses to determine the data privacy integration protocol result can include evaluating work package responses from vetoing applications that include minimum remaining processing time information to determine, as the data privacy integration protocol result, a maximum minimum remaining processing time timestamp from among the vetoing applications that represents an earliest time at which a consensus non-veto vote can occur for the object in the multiple-application landscape.

At 1814, the data privacy integration protocol result is provided, in response to the data privacy integration protocol request.

A second data privacy integration protocol can be received request for the object at a first time before the maximum minimum remaining processing time timestamp. A determination can be made that the first time is before the maximum minimum remaining processing time timestamp. In response to determining that the first time is before the maximum minimum remaining processing time timestamp, a response can be provided to the second data privacy integration protocol request that indicates that the maximum minimum remaining processing time timestamp represents the earliest time at which the consensus non-veto vote can occur for the object in the multiple-application landscape.

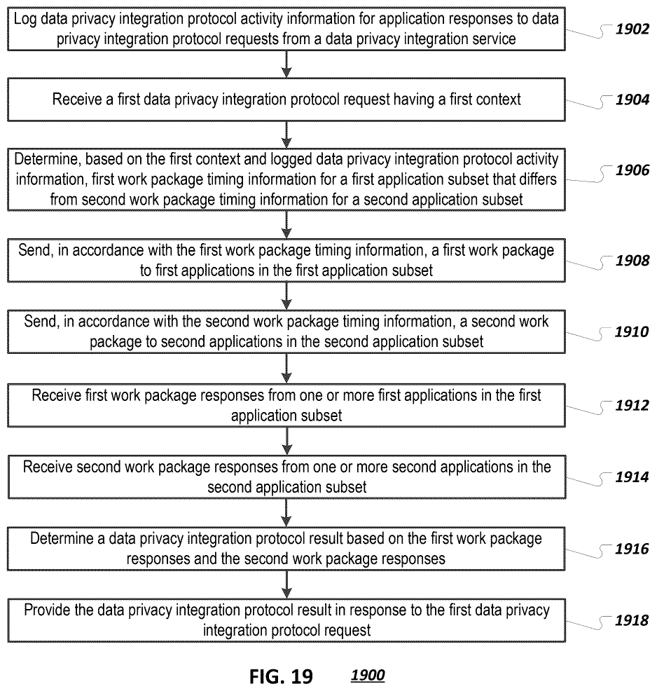

FIG. 19 is a flowchart of an example method 1900 for improving scheduling of data privacy integration protocol processing based on application availability. It will be understood that method 1900 and related methods may be performed, for example, by any suitable system, environment, software, and hardware, or a combination of systems, environments, software, and hardware, as appropriate. For example, one or more of a client, a server, or other computing device can be used to execute method 1900 and related methods and obtain any data from the memory of a client, the server, or the other computing device. In some implementations, the method 1900 and related methods are executed by one or more components of the system 100 described above with respect to FIG. 1. For example, the method 1900 and related methods can be executed by the data privacy integration service 117 of FIG. 1.

At 1902, data privacy integration protocol activity information are logged, for application responses to data privacy integration protocol requests from a data privacy integration service that manages data privacy integration for applications in a multiple-application landscape

At 1904, a first data privacy integration protocol request having a first context is received at the data privacy integration service. The first context can include a temporal context of one or more of day of week, time of day, or time of year. The first context can include an object type of an object specified in the first data privacy integration protocol request, a number of objects specified in the first data privacy integration protocol request, or a type of the first data privacy integration protocol request. The type of the first data privacy integration protocol request can be an integrated end of purpose protocol request which requests the data privacy integration service to determine whether each landscape application in the multiple-application landscape can block an object. The type of the first data privacy integration protocol request can be an aligned purpose disassociation protocol request which requests the data privacy integration service to determine whether each landscape application in the multiple-application landscape can disassociate a purpose from the object.

At 1906, first work package timing information for a first application subset that differs from second work package timing information for a second application subset is determined based on the first context and logged data privacy integration protocol activity information. The first work package timing information can include a first scheduled work package sending time determined for the first application subset based on predicted upcoming availability of first applications in the first application subset. The first work package timing information can be determined using a machine learning model.

At 1908, a first work package is sent to first applications in the first application subset in accordance with the first work package timing information. Sending the first work package to the first applications in the first application subset in accordance with the first work package timing information can include sending the first work package at the first scheduled work package sending time. Sending the first work package to the first applications in the first application subset at the first scheduled work package sending time can reduce a likelihood of the first applications in the first application subset encountering a work package timeout before completing processing of the first work package.

The first work package timing information can include a first work package timeout value determined for the first applications in the first application subset based on predicting that the first applications in the first application subset may need at least a threshold amount of time longer for processing the first work package than an amount of time predicted for processing the second work package by the second applications in the second application subset. Using the first work package timeout value for the first work package can reduce a likelihood of each first application in the first application subset encountering a work package timeout before completing processing of the first work package.

At 1910, a second work package is sent to second applications in the second application subset in accordance with the second work package timing information. The second work package timing information can include an immediate work package sending time determined for the second applications in the second application subset based on predicted immediate availability of the second applications in the second application subset. The second work package timing information can include a default work package timeout value that is shorter than the first work package timeout value.

At 1912, one or more first work package responses are received from one or more first applications in the first application subset.

At 1914, one or more second work package responses are received from one or more second applications in the second application subset. At least some of the second work package responses from second applications in the second application subset can be received before first work package responses from first applications in the first application subset.

At 1916, a data privacy integration protocol result is determined based on the first work package responses and the second work package responses.

At 1918, the data privacy integration protocol result is provided in response to the first data privacy integration protocol request.

A determination can be made to send a third work package to third applications in a third application subset based on none of the first work package responses or the second work package responses indicating a veto data privacy integration protocol vote. The veto data privacy integration protocol vote for a landscape application for a first object can indicate that the landscape application cannot block the first object or cannot disassociate a purpose from the first object.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

In view of the above described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method comprising:
receiving, at a data privacy integration service that manages data privacy integration for a multiple-application landscape, a first request to start a data privacy integration protocol for a first object instance;
sending, by the data privacy integration service, at least one second request to at least one other service, for information regarding which applications of the multiple-application landscape have received a copy of the first object instance;
receiving, by the data privacy integration service and from the at least one other service, the information indicating a subset of applications of the multiple-application landscape that have received a copy of the first object instance;
creating a work package for the first object instance and the data privacy integration protocol;
   sending the work package for the first object instance to applications in the subset of applications and not sending the work package to landscape applications not in the subset of applications;
receiving work package responses from applications in the subset of applications;
   determining a data privacy integration protocol result based on the work package responses; and
sending, in response to the first request to start the data privacy integration protocol, the data privacy integration protocol result.

Example 2. The computer-implemented method of Example 1, wherein the first object instance is a master data object instance representing a first data subject.

Example 3. The computer-implemented method of any of the preceding Examples, wherein the at least one other service comprises a master data integration service that distributes master data objects to applications in the multiple-application landscape.

Example 4. The computer-implemented method of any of the preceding Examples, wherein the master data integration service maintains master data distribution records which indicate master data object instances have been distributed to which downstream applications in the multiple-application landscape.

Example 5. The computer-implemented method of any of the preceding Examples, wherein the master data integration service determines, based on the master data distribution records and in response to the second request from the data privacy integration service, the information regarding which applications of the multiple-application landscape have received a copy of the first object instance.

Example 6. The computer-implemented method of any of the preceding Examples, wherein the at least one other service comprises a proxy service that integrates with applications that do not integrate with the master data integration service.

Example 7. The computer-implemented method of any of the preceding Examples, wherein the proxy service is configured to determine which applications, of the applications that do not integrate with the master data integration service, have received a copy of the first object instance.

Example 8. The computer-implemented method of any of the preceding Examples, wherein the data privacy integration service sends the second request to the master data integration service but not the proxy service, based on the multiple-application landscape only having applications that integrate with the master data integration service.

Example 9. The computer-implemented method of any of the preceding Examples, wherein the data privacy integration service sends the second request to both the master data integration service and the proxy service, based on the multiple-application landscape having both applications that integrate with the master data integration service and at least one application that does not integrate with the master data integration service.

Example 10. The computer-implemented method of any of the preceding Examples, wherein the data privacy integration protocol is an integrated end of purpose protocol in which a respective responding application provides a vote for an object indicating whether the respective responding application can block the object.

Example 11. The computer-implemented method of any of the preceding Examples, wherein the data privacy integration protocol is an aligned purpose disassociation protocol in which a respective responding application provides a vote for an object indicating whether the respective responding application can disassociate a purpose from the object.

Example 12. The computer-implemented method of any of the preceding Examples, wherein the at least one other service includes a semantic service that determines, in response to the second request, which applications have received the copy of the first object instance based on semantics of an object identifier of the first object instance.

Example 13. The computer-implemented method of any of the preceding Examples, further comprising:
receiving, at the data privacy integration service, a second data privacy integration request for the data privacy integration protocol; and
determining to send a data privacy integration work package for the second data privacy integration request to all applications in the multiple-application landscape and to not send the second request to the at least one other service.

Example 14. A system comprising:
one or more computers; and
a computer-readable medium coupled to the one or more computers having instructions stored thereon which, when executed by the one or more computers, cause the one or more computers to perform operations comprising:
   receiving, at a data privacy integration service that manages data privacy integration for a multiple-application landscape, a first request to start a data privacy integration protocol for a first object instance;
   sending, by the data privacy integration service, at least one second request to at least one other service, for information regarding which applications of the multiple-application landscape have received a copy of the first object instance;
   receiving, by the data privacy integration service and from the at least one other service, the information indicating a subset of applications of the multiple-application landscape that have received a copy of the first object instance;
   creating a work package for the first object instance and the data privacy integration protocol;
      sending the work package for the first object instance to applications in the subset of applications and not sending the work package to landscape applications not in the subset of applications;
   receiving work package responses from applications in the subset of applications;
      determining a data privacy integration protocol result based on the work package responses; and
   sending, in response to the first request to start the data privacy integration protocol, the data privacy integration protocol result.

Example 15. The system of Example 14, wherein the first object instance is a master data object instance representing a first data subject.

Example 16. The system of any of the preceding Examples, wherein the at least one other service comprises a master data integration service that distributes master data objects to applications in the multiple-application landscape.

Example 17. The system of any of the preceding Examples, wherein the master data integration service maintains master data distribution records which indicate master data object instances have been distributed to which downstream applications in the multiple-application landscape.

Example 18. A computer program product encoded on a non-transitory storage medium, the product comprising non-transitory, computer readable instructions for causing one or more processors to perform operations comprising:
receiving, at a data privacy integration service that manages data privacy integration for a multiple-application landscape, a first request to start a data privacy integration protocol for a first object instance;
sending, by the data privacy integration service, at least one second request to at least one other service, for information regarding which applications of the multiple-application landscape have received a copy of the first object instance;
receiving, by the data privacy integration service and from the at least one other service, the information indicating a subset of applications of the multiple-application landscape that have received a copy of the first object instance;
creating a work package for the first object instance and the data privacy integration protocol;
   sending the work package for the first object instance to applications in the subset of applications and not sending the work package to landscape applications not in the subset of applications;
receiving work package responses from applications in the subset of applications;
   determining a data privacy integration protocol result based on the work package responses; and
sending, in response to the first request to start the data privacy integration protocol, the data privacy integration protocol result.

Example 19. The computer program product of Example 18, wherein the first object instance is a master data object instance representing a first data subject.

Example 20. The computer program Example 18 or 19, wherein the at least one other service comprises a master data integration service that distributes master data objects to applications in the multiple-application landscape.

What is claimed is:

1. A computer-implemented method comprising:
receiving, at a data privacy integration service that manages data privacy integration for a multiple-application landscape, a first request to start a data privacy integration protocol for a first object instance;
sending, by the data privacy integration service, at least one second request to at least one other service, for information regarding which applications of the multiple-application landscape have received a copy of the first object instance;
receiving, by the data privacy integration service and from the at least one other service, the information indicating a subset of applications of the multiple-application landscape that have received a copy of the first object instance;
creating a work package for the first object instance and the data privacy integration protocol;
sending the work package for the first object instance to applications in the subset of applications and not sending the work package to landscape applications not in the subset of applications;
receiving work package responses from applications in the subset of applications;
determining a data privacy integration protocol result based on the work package responses; and
sending, in response to the first request to start the data privacy integration protocol, the data privacy integration protocol result.

2. The computer-implemented method of claim 1, wherein the first object instance is a master data object instance representing a first data subject.

3. The computer-implemented method of claim 1, wherein the at least one other service comprises a master data integration service that distributes master data objects to applications in the multiple-application landscape.

4. The computer-implemented method of claim 3, wherein the master data integration service maintains master data distribution records which indicate master data object instances have been distributed to which downstream applications in the multiple-application landscape.

5. The computer-implemented method of claim 4, wherein the master data integration service determines, based on the master data distribution records and in response to the second request from the data privacy integration service, the information regarding which applications of the multiple-application landscape have received a copy of the first object instance.

6. The computer-implemented method of claim 3, wherein the at least one other service comprises a proxy service that integrates with applications that do not integrate with the master data integration service.

7. The computer-implemented method of claim 6, wherein the proxy service is configured to determine which applications, of the applications that do not integrate with the master data integration service, have received a copy of the first object instance.

8. The computer-implemented method of claim 6, wherein the data privacy integration service sends the second request to the master data integration service but not the proxy service, based on the multiple-application landscape only having applications that integrate with the master data integration service.

9. The computer-implemented method of claim 6, wherein the data privacy integration service sends the second request to both the master data integration service and the proxy service, based on the multiple-application landscape having both applications that integrate with the master data integration service and at least one application that does not integrate with the master data integration service.

10. The computer-implemented method of claim 1, wherein the data privacy integration protocol is an integrated end of purpose protocol in which a respective responding application provides a vote for an object indicating whether the respective responding application can block the object.

11. The computer-implemented method of claim 1, wherein the data privacy integration protocol is an aligned purpose disassociation protocol in which a respective responding application provides a vote for an object indicating whether the respective responding application can disassociate a purpose from the object.

12. The computer-implemented method of claim 1, wherein the at least one other service includes a semantic service that determines, in response to the second request, which applications have received the copy of the first object instance based on semantics of an object identifier of the first object instance.

13. The computer-implemented method of claim 1, further comprising:
receiving, at the data privacy integration service, a second data privacy integration request for the data privacy integration protocol; and
determining to send a data privacy integration work package for the second data privacy integration request to all applications in the multiple-application landscape and to not send the second request to the at least one other service.

14. A system comprising:
one or more computers; and
a computer-readable medium coupled to the one or more computers having instructions stored thereon which, when executed by the one or more computers, cause the one or more computers to perform operations comprising:
receiving, at a data privacy integration service that manages data privacy integration for a multiple-application landscape, a first request to start a data privacy integration protocol for a first object instance;
sending, by the data privacy integration service, at least one second request to at least one other service, for information regarding which applications of the multiple-application landscape have received a copy of the first object instance;
receiving, by the data privacy integration service and from the at least one other service, the information indicating a subset of applications of the multiple-application landscape that have received a copy of the first object instance;
creating a work package for the first object instance and the data privacy integration protocol;
sending the work package for the first object instance to applications in the subset of applications and not sending the work package to landscape applications not in the subset of applications;
receiving work package responses from applications in the subset of applications;
determining a data privacy integration protocol result based on the work package responses; and
sending, in response to the first request to start the data privacy integration protocol, the data privacy integration protocol result.

15. The system of claim 14, wherein the first object instance is a master data object instance representing a first data subject.

16. The system of claim 14, wherein the at least one other service comprises a master data integration service that distributes master data objects to applications in the multiple-application landscape.

17. The system of claim 16, wherein the master data integration service maintains master data distribution records which indicate master data object instances have been distributed to which downstream applications in the multiple-application landscape.

18. A computer program product encoded on a non-transitory storage medium, the product comprising non-transitory, computer readable instructions for causing one or more processors to perform operations comprising:
receiving, at a data privacy integration service that manages data privacy integration for a multiple-application landscape, a first request to start a data privacy integration protocol for a first object instance;
sending, by the data privacy integration service, at least one second request to at least one other service, for information regarding which applications of the multiple-application landscape have received a copy of the first object instance;
receiving, by the data privacy integration service and from the at least one other service, the information indicating a subset of applications of the multiple-application landscape that have received a copy of the first object instance;
creating a work package for the first object instance and the data privacy integration protocol;
sending the work package for the first object instance to applications in the subset of applications and not sending the work package to landscape applications not in the subset of applications;
receiving work package responses from applications in the subset of applications;
determining a data privacy integration protocol result based on the work package responses; and
sending, in response to the first request to start the data privacy integration protocol, the data privacy integration protocol result.

19. The computer program product of claim 18, wherein the first object instance is a master data object instance representing a first data subject.

20. The computer program product of claim 18, wherein the at least one other service comprises a master data integration service that distributes master data objects to applications in the multiple-application landscape.
